(19) United States
(12) Patent Application Publication
(10) Pub. No.: US 2008/0265045 A1
(43) Pub. Date: Oct. 30, 2008

(54) Humidity Control System

(76) Inventors: Tomohiro Yabu, Osaka (JP); Ryusuke Fujiyoshi, Osaka (JP)

Correspondence Address: BIRCH STEWART KOLASCH & BIRCH, PO BOX 747, FALLS CHURCH, VA, 22040-0747, US

(21) Appl. No.: 11/547,188

(22) PCT Filed: Mar. 30, 2005
(86) PCT No.: PCT/JP2005/006106

§ 371 Date: Sep. 29, 2006

(30) Foreign Application Priority Data
Mar. 31, 2004 (JP) 2004-101744

(51) Int. Cl. F24F 11/02; G05B 19/00

(52) U.S. Cl. 236/44 C; 700/276

(57) ABSTRACT

A humidity control system (10) is constituted by a single outdoor unit (13) and two humidity control units (11, 12). The two humidity control units (11, 12) are connected to the outdoor unit (13). With switching of the position of an outdoor four-way selector valve (22) in the outdoor unit (13), the flow direction of refrigerant in humidity control circuits (30, 40) in the humidity control units (11, 12) is inverted. Out of a first adsorption heat exchanger (31, 41) and a second adsorption heat exchanger (32, 42) in each humidity control circuit (30, 40), one serving as an evaporator dehumidifies a first air and the other serving as a condenser humidifies a second air. Each humidity control unit (11, 12) performs a dehumidification operation by supplying the dehumidified first air to a room and performs a humidification operation by supplying the humidified second air to the room. Each humidity control unit (11) is capable of selecting either the dehumidification operation or the humidification operation regardless of during which operation the other humidity control unit (12) is.

### TECHNICAL FIELD

This invention relates to humidity control systems for supplying dehumidified or humidified air to rooms.

### BACKGROUND ART

A humidity control system is hitherto known for controlling air humidity using an adsorbent as disclosed in Patent Document 1. The humidity control system includes an adsorption element carrying an adsorbent and allows water vapor in the air to be adsorbed on the adsorption element to dehumidify the air. The humidity control system also includes a refrigerant circuit for operating in a refrigeration cycle and is configured to heat the adsorption element with the air heated by a condenser in the refrigerant circuit and humidify the air with the water vapor desorbed from the adsorption element. Further, the humidity control system supplies one of the dehumidified air and the humidified air to a room and exhausts the other to the outside atmosphere.

### Patent Document 1: Published Japanese Patent Application No. 2003-232539

### DISCLOSURE OF THE INVENTION

### Problems to be Solved by the Invention

The humidity control system in Patent Document 1 supplies humidity-controlled air through a duct to the room. Then, if the humidity-controlled air is distributed to a plurality of rooms, the plurality of rooms can be dehumidified or humidified by a single humidity control system. In this case, either the dehumidified air or the humidified air is concurrently supplied to all the rooms.

However, each room may have a different purpose or condition of usage: there may be a circumstance where a particular room requires dehumidification but another room requires humidification. The aforesaid manner of distributing the air humidity-controlled by a single humidity control system to a plurality of rooms cannot deal with such a circumstance where rooms requiring dehumidification and rooms requiring humidification coexist. Therefore, when used for humidity control of the plurality of rooms, the single humidity control system may be inconvenient.

The present invention has been made in view of the foregoing point and, therefore, its object is to provide a humidity control system convenient for humidity control of a plurality of rooms.

### Means for Solving the Problems

A first solution of the invention is directed to a humidity control system. The humidity control system comprises: a plurality of humidity control units (11, 12) each for selectively performing a dehumidification operation of supplying dehumidified air to a room and a humidification operation of supplying humidified air to the room; a single compressor unit (13) having a compressor (21) disposed therein; each said humidity control unit (11, 12) being connected to the compressor unit (13) to form a refrigerant circuit (15) and configured to control the humidity of air by carrying out at least one of heating and cooling of an adsorbent using refrigerant in the refrigerant circuit (15) and bringing the air into contact with the adsorbent; and any one of the humidity control units (11, 12) being capable of selecting either the dehumidification operation or the humidification operation regardless of the other humidity control units (11, 12) being during dehumidification operation or humidification operation.

A second solution of the invention is directed to the first solution, wherein each said humidity control unit (11, 12) includes an adsorption heat exchanger (31, 32, 41, 42) carrying the adsorbent and connected to the refrigerant circuit (15) and is configured to feed air taken therein to the adsorption heat exchanger (31, 32, 41, 42) and bring the air into contact with the adsorbent.

A third solution of the invention is directed to the second solution, wherein each said humidity control unit (11, 12) is configured to take a first air and a second air and alternately perform a mode of dehumidifying the first air in a first adsorption heat exchanger (31, 41) serving as an evaporator and humidifying the second air in a second adsorption heat exchanger (32, 42) serving as a condenser and another mode of dehumidifying the first air in the second adsorption heat exchanger (32, 42) serving as an evaporator and humidifying the second air in the first adsorption heat exchanger (31, 41) serving as a condenser, and each said humidity control unit (11, 12) is configured, during dehumidification operation, to supply the dehumidified first air to the room while exhausting the humidified second air to the outside atmosphere and is configured, during humidification operation, to supply the humidified second air to the room while exhausting the dehumidified first air to the outside atmosphere.

A fourth solution of the invention is directed to the third solution, whereineach said humidity control unit (11, 12) includes a humidity control circuit (30, 40) formed therein by connecting the first adsorption heat exchanger (31, 41), an expansion mechanism (33, 43) and the second adsorption heat exchanger (32, 42) in series in this order, said humidity control circuit (30, 40) constituting part of the refrigerant circuit (15), and the compressor unit (13) includes an inversion mechanism (22), connected to the refrigerant circuit (15), for inverting the direction of flow of the refrigerant through all the humidity control circuits (30, 40).

A fifth solution of the invention is directed to the third solution, wherein each said humidity control unit (11, 12) includes a humidity control circuit (30, 40) formed therein by connecting the first adsorption heat exchanger (31, 41), an expansion mechanism (33, 43) and the second adsorption heat exchanger (32, 42) in series in this order, said humidity control circuit (30, 40) constituting part of the refrigerant circuit (15), and the humidity control circuit (30, 40) includes an inversion mechanism (34, 44) connected therein for inverting the direction of flow of the refrigerant through the humidity control circuit (30, 40).

—Behaviors—

In the first solution of the present invention, the humidity control system (10) comprises a single compressor unit (13) and a plurality of humidity control units (11, 12). Each of the plurality of humidity control units (11, 12) is connected to the compressor unit (13). The humidity control units (11, 12) and the compressor unit (13) connected together form a refrigerant circuit (15). When the compressor in the compressor unit (13) is driven, refrigerant circulates through the refrigerant circuit (15) to provide a refrigeration cycle. Each of the plurality of humidity control units (11, 12) included in the inventive humidity control system (10) can perform a dehumidification operation and a humidification operation. Each humidity control unit (11, 12) controls air humidity by transferring water vapor between the air and the adsorbent and supplies, during dehumidification operation, the dehumidified air to a room or, during humidification operation, the humidified air to the room. During these operations, the humidity control unit (11, 12) uses the refrigerant flowing through the refrigerant circuit (15) to carry out either or both of adsorbent heating and adsorbent cooling. Heating of the adsorbent promotes desorption of water vapor from the adsorbent, while cooling of the adsorbent promotes adsorption of water vapor on the adsorbent.

In the above inventive humidity control system (10), each humidity control unit (11, 12) can individually select a dehumidification operation or a humidification operation. In other words, any one of the humidity control units (11, 12) included in the humidity control system (10) can perform either a dehumidification operation or a humidification operation regardless of whether the rest of the humidity control units (11, 12) are during dehumidification operation or humidification operation.

In the second solution of the present invention, each humidity control unit (11, 12) includes an adsorption heat exchanger (31, 32, 41, 42). The adsorption heat exchanger (31, 32, 41, 42) carries an adsorbent and the adsorbent is brought into contact with the air passing through the adsorption heat exchanger (31, 32, 41, 42). The adsorption heat exchanger (31, 32, 41, 42) is connected to the refrigerant circuit (15). With the adsorption heat exchanger (31, 32, 41, 42) serving as a condenser, the adsorbent carried on the adsorption heat exchanger (31, 32, 41, 42) is heated by the refrigerant in the refrigerant circuit (15). With the adsorption heat exchanger (31, 32, 41, 42) serving as an evaporator, the adsorbent carried on the adsorption heat exchanger (31, 32, 41, 42) is cooled by the refrigerant in the refrigerant circuit (15).

In the third solution of the present invention, each humidity control unit (11, 12) includes a plurality of adsorption heat exchangers (31, 32, 41, 42). Each of these adsorption heat exchangers (31, 32, 41, 42) alternately repeats two modes. Specifically, in one of the two modes of the humidity control unit (11, 12), the first adsorption heat exchanger (31, 41) serves as an evaporator and the second adsorption heat exchanger (32, 42) serves as a condenser, whereby the first air is dehumidified in the first adsorption heat exchanger (31, 41) and the second air is humidified in the second adsorption heat exchanger (32, 42). On the other hand, in the other mode of the humidity control unit (11, 12), the second adsorption heat exchanger (32, 42) serves as an evaporator and the first adsorption heat exchanger (31, 41) serves as a condenser, whereby the first air is dehumidified in the second adsorption heat exchanger (32, 42) and the second air is humidified in the first adsorption heat exchanger (31, 41). In other words, each adsorption heat exchanger (31, 32, 41, 42) in each humidity control unit (11, 12) alternate dehumidification of the first air and humidification of the second air. Further, each humidity control unit (11, 12) supplies one of the first air and the second air having passed through the respective adsorption heat exchangers (31, 32, 41, 42) to a room and exhausts the other to the outside atmosphere.

In the fourth and fifth solutions of the present invention, a humidity control circuit (30, 40) is formed in each humidity control unit (11, 12). In the humidity control circuit (30, 40) of each humidity control unit (11, 12), the first adsorption heat exchanger (31, 41), an expansion mechanism (33, 43) and the second adsorption heat exchanger (32, 42) are connected in series in this order. When the refrigerant flows through the humidity control circuit (30, 40) from the first adsorption heat exchanger (31, 41) toward the second adsorption heat exchanger (32, 42), the first adsorption heat exchanger (31, 41) serves as a condenser and the second adsorption heat exchanger (32, 42) serves as an evaporator. On the contrary, when the refrigerant flows from the second adsorption heat exchanger (32, 42) toward the first adsorption heat exchanger (31, 41), the second adsorption heat exchanger (32, 42) serves as a condenser and the first adsorption heat exchanger (31, 41) serves as an evaporator.

Furthermore, in the fourth solution, the compressor unit (13) has an inversion mechanism (22) disposed therein. The inversion mechanism (22) is connected to the refrigerant circuit (15). The direction of flow of the refrigerant through the humidity control circuits (30, 40) in all the humidity control units (11, 12) can be inverted by the actuation of the inversion mechanism (22) disposed in the compressor unit (13). On the other hand, in the fifth solution, an inversion mechanism (34, 44) is provided in the humidity control circuit (30, 40) in each humidity control unit (11, 12). In other words, in this solution, each humidity control circuit (30, 40) has an inversion mechanism (34, 44) disposed therein. When the inversion mechanism (34, 44) in one of the humidity control units (11, 12) is actuated, only the humidity control circuit (30, 40) in the associated humidity control unit (11, 12) inverts the flow direction of refrigerant.

### EFFECTS OF THE INVENTION

In the present invention, each humidity control unit (11, 12) of the humidity control system (10) is configured to be able to individually select whether it performs a dehumidification operation or a humidification operation. Therefore, if the humidity control units (11, 12) supply humidity-controlled air to different rooms, each humidity control unit (11, 12) can select either a dehumidification operation or a humidification operation according to the circumstances of the associated room. Specifically, under a circumstance where some rooms require dehumidification and the others require humidification, dehumidification operation can be carried out in the humidity control units (11, 12) for supplying air to the rooms requiring dehumidification, while humidification operation can be carried in the humidity control units (11, 12) for supplying air to the rooms requiring humidification. Therefore, according to the present invention, each humidity control unit (11, 12) can perform an operation according to the request from the associated room, which provides a humidity control system (10) convenient for humidity control for a plurality of rooms.

According to the second solution, since the adsorption heat exchangers (31, 32, 41, 42) connected in the refrigerant circuit (15) carry adsorbents, the adsorbents can be efficiently heated or cooled by the refrigerant in the refrigerant circuit (15). As a result, the amount of water vapor transferred between the adsorbents and air can be increased, thereby providing enhanced performance of the humidity control units (11, 12) or downsized humidity control units (11, 12).

In the third solution, each humidity control unit (11, 12) operates in batches so that one of the first and second adsorption heat exchangers (31, 32, 41, 42) adsorbs water vapor while the other is regenerated. Therefore, according to the present invention, each humidity control unit (11, 12) can continuously produce a dehumidified first air and a humidified second air and continuously supply the obtained first or second air to the room.

Furthermore, in each humidity control unit (11, 12) in the third solution, out of the first and second adsorption heat exchangers (31, 32, 41, 42), one for dehumidifying the first air serves as an evaporator and the other for humidifying the second air serves as a condenser. Therefore, in the adsorption heat exchanger (31, 32, 41, 42) serving as an evaporator, the adsorbent is cooled by the refrigerant in the refrigerant circuit (15) to promote the adsorption of water vapor in the air on the adsorbent. On the other hand, in the adsorption heat exchanger (31, 32, 41, 42) serving as a condenser, the adsorbent is heated by the refrigerant in the refrigerant circuit (15) to promote the desorption of water vapor from the adsorbent. Therefore, according to the present invention, both the adsorption of water vapor on the adsorbent and desorption of water vapor from the adsorbent can be promoted, which provides enhanced performance of the humidity control units (11, 12) or downsized humidity control units (11, 12).

In the fourth solution, the inversion mechanism (22) disposed in the compressor unit (13) inverts the flow direction of refrigerant in all the humidity control circuits (30, 40). In other words, only with the inversion mechanism (22) in the compressor unit (13), switching of the flow direction of refrigerant in the humidity control circuits (30, 40) associated with mode switching is implemented. Therefore, according to the present invention, the number of parts disposed in the refrigerant circuit (15) can be minimized, which provides a simplified humidity control system (10).

Furthermore, the inversion mechanism (22) is actuated with a relatively high frequency and therefore has a high possibility of causing noises. To cope with this, in the fourth solution, the inversion mechanism (22) is disposed in the compressor unit (13) very likely to be installed outside the house. Therefore, according to the present invention, troubles with noises produced in association with the actuation of the inversion mechanism (22) can be avoided.

In the fifth solution, an inversion mechanism (34, 44) is disposed in each of the humidity control units (11, 12). Therefore, the flow direction of refrigerant in the humidity control circuit (30, 40) in each humidity control unit (11, 12) can be individually selected by the associated inversion mechanism (34, 44). Consequently, according to the present invention, the timing to switch the mode can be set for each humidity control unit (11, 12).

### BRIEF DESCRIPTION OF DRAWINGS

FIG. 1 is a refrigerant circuit diagram showing a schematic structure of a humidity control system according to Embodiment 1 and the behavior thereof when both the humidity control units are during dehumidification operation, wherein FIG. 1A shows the flows of air and refrigerant in a first mode and FIG. 1B shows the flows of air and refrigerant in a second mode.

FIG. 2 is a refrigerant circuit diagram showing the schematic structure of the humidity control system according to Embodiment 1 and the behavior thereof when both the humidity control units are during humidification operation, wherein FIG. 2A shows the flows of air and refrigerant in a first mode and FIG. 2B shows the flows of air and refrigerant in a second mode.

FIG. 3 is a refrigerant circuit diagram showing the schematic structure of the humidity control system according to Embodiment 1 and the behavior thereof when the first humidity control unit is during dehumidification operation and the second humidity control unit is during humidification operation, wherein FIG. 3A shows the flows of air and refrigerant in a first mode and FIG. 3B shows the flows of air and refrigerant in a second mode.

FIG. 4 is a perspective view showing the structure of the humidity control unit in Embodiment 1.

FIG. 5 illustrates plan, left side and right side views showing a schematic structure of the humidity control unit in Embodiment 1.

FIG. 6 illustrates schematic plan, left side and right side views of the humidity control unit in Embodiment 1, showing the first mode of the dehumidification operation.

FIG. 7 illustrates schematic plan, left side and right side views of the humidity control unit in Embodiment 1, showing the second mode of the dehumidification operation.

FIG. 8 illustrates schematic plan, left side and right side views of the humidity control unit in Embodiment 1, showing the first mode of the humidification operation.

FIG. 9 illustrates schematic plan, left side and right side views of the humidity control unit in Embodiment 1, showing the second mode of the humidification operation.

FIG. 10 illustrates schematic plan, left side and right side views of the humidity control unit in Modification 1 of Embodiment 1, showing a first mode of a dehumidification operation.

FIG. 11 illustrates schematic plan, left side and right side views of the humidity control unit in Modification 1 of Embodiment 1, showing a second mode of the dehumidification operation.

FIG. 12 illustrates schematic plan, left side and right side views of the humidity control unit in Modification 2 of Embodiment 1, showing a first mode of a humidification operation.

FIG. 13 illustrates schematic plan, left side and right side views of the humidity control unit in Modification 2 of Embodiment 1, showing a second mode of the humidification operation.

FIG. 14 illustrates schematic plan, left side and right side views of the humidity control unit in Modification 3 of Embodiment 1, showing a second mode of a dehumidification operation.

FIG. 15 illustrates schematic plan, left side and right side views of the humidity control unit in Modification 3 of Embodiment 1, showing a second mode of a humidification operation.

FIG. 16 illustrates schematic plan, left side and right side views of the humidity control unit in Modification 4 of Embodiment 1, showing a second mode of a dehumidification operation.

FIG. 17 illustrates schematic plan, left side and right side views of the humidity control unit in Modification 4 of Embodiment 1, showing a second mode of a humidification operation.

FIG. 18 is a refrigerant circuit diagram showing a schematic structure of a humidity control system according to Embodiment 2 and the behavior thereof when both the humidity control units are during dehumidification operation, wherein FIG. 18A shows the flows of air and refrigerant in a first mode and FIG. 18B shows the flows of air and refrigerant in a second mode.

FIG. 19 is a refrigerant circuit diagram showing the schematic structure of the humidity control system according to Embodiment 2 and the behavior thereof when both the humidity control units are during humidification operation, wherein FIG. 19A shows the flows of air and refrigerant in a first mode and FIG. 19B shows the flows of air and refrigerant in a second mode.

FIG. 20 is a refrigerant circuit diagram showing the schematic structure of the humidity control system according to Embodiment 2 and the behavior thereof when the first humidity control unit is during dehumidification operation and the second humidity control unit is during humidification operation.

FIG. 21 illustrates schematic plan, left side and right side views of a humidity control unit in Embodiment 3, showing a first mode of a dehumidification operation.

FIG. 22 illustrates schematic plan, left side and right side views of the humidity control unit in Embodiment 3, showing a second mode of the dehumidification operation.

FIG. 23 illustrates schematic plan, left side and right side views of the humidity control unit in Embodiment 3, showing a first mode of a humidification operation.

FIG. 24 illustrates schematic plan, left side and right side views of the humidity control unit in Embodiment 3, showing a second mode of the humidification operation.

### EXPLANATION OF REFERENCE NUMERALS

10 humidity control system
11 first humidity control unit
12 second humidity control unit
13 outdoor unit (compressor unit)
15 refrigerant circuit
22 outdoor four-way selector valve (inversion mechanism)
30 humidity control circuit
31 first adsorption heat exchanger
32 second adsorption heat exchanger
33 motor-operated expansion valve (expansion mechanism)
34 humidity control four-way selector valve (inversion mechanism)
40 humidity control circuit
41 first adsorption heat exchanger
42 second adsorption heat exchanger
43 motor-operated expansion valve (expansion mechanism)
44 humidity control four-way selector valve inversion mechanism)

### BEST MODE FOR CARRYING OUT THE INVENTION

Embodiments of the present invention will be described below in detail with reference to the drawings. Note that the following embodiments are preferred examples in nature and not intended to limit the scope, applications and use of the invention.

### Embodiment 1 of the Invention

A description is given of Embodiment 1 of the invention. This embodiment is a humidity control system (10) for supplying humidity-controlled air to rooms.

<General Structure of Humidity Control System>

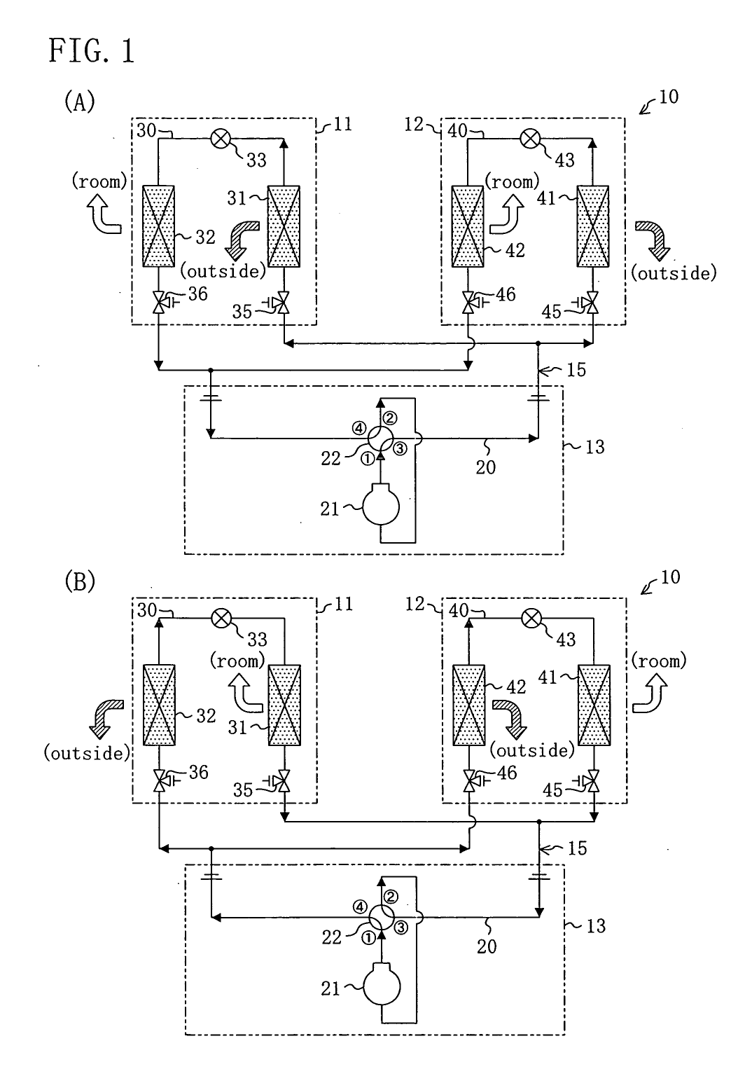

As shown in FIG. 1, the humidity control system (10) includes a first humidity control unit (11), a second humidity control unit (12) and an outdoor unit (13) serving as a compressor unit. In the humidity control system (10), a refrigerant circuit (15) is formed by connecting the two humidity control units (11, 12) to the single outdoor unit (13). Note that the number of humidity control units (11, 12) connected to the outdoor unit (13) may be three or more.

The first humidity control unit (11) and the second humidity control unit (12) contain their respective humidity control circuits (30, 40). The details of the humidity control units (11, 12) will be described later.

The humidity control circuit (30, 40) in each humidity control unit (11, 12) is configured similarly. Specifically, each humidity control circuit (30, 40) is provided with two adsorption heat exchangers (31, 32, 41, 42), two shut-off valves (35, 36, 45, 46) and a single motor-operated expansion valve (33, 43) serving as an expansion mechanism. In each humidity control circuit (30, 40), a first shut-off valve (35, 45) is disposed at one end and a second shut-off valve (36, 46) is disposed at the other end. Further, in each humidity control circuit (30, 40), the first adsorption heat exchanger (31, 41), the motor-operated expansion valve (33, 43) and the second adsorption heat exchanger (32, 42) are arranged in order from the first shut-off valve (35, 45) toward the second shut-off valve (36, 46).

The first and second adsorption heat exchangers (31, 32, 41, 42) in the humidity control circuits (30, 40) are all cross fin type fin-and-tube heat exchanges composed of a heat exchanger tube and a large number of fins. Each adsorption heat exchanger (31, 32, 41, 42) has an adsorbent carried on the fin surfaces. Adsorbents used include zeolite and silica gel.

The outdoor unit (13) contains an outdoor circuit (20). The outdoor circuit (20) is provided with a compressor (21) and an outdoor four-way selector valve (22). In the outdoor circuit (20), the compressor (21) is connected at its discharge side to the first port of the outdoor four-way selector valve (22) and connected at its suction side to the second port of the outdoor four-way selector valve (22). The third port of the outdoor four-way selector valve (22) is connected through connection pipes to the first shut-off valves (35, 45) of the humidity control circuits (30, 40). On the other hand, the fourth port of the outdoor four-way selector valve (22) is connected through other connection pipes to the second shut-off valves (36, 46) of the humidity control circuits (30, 40). The outdoor four-way selector valve (22) switches between a first position in which the first and third ports communicate with each other and the second and fourth ports communicate with each other (the position shown in FIG. 1A) and a second position in which the first and fourth ports communicate with each other and the second and third ports communicate with each other (the position shown in FIG. 1B). The outdoor four-way selector valve (22) constitutes an inversion mechanism for inverting the flow direction of refrigerant in all the humidity control circuits (30, 40).

<Structure of Humidity Control Unit>

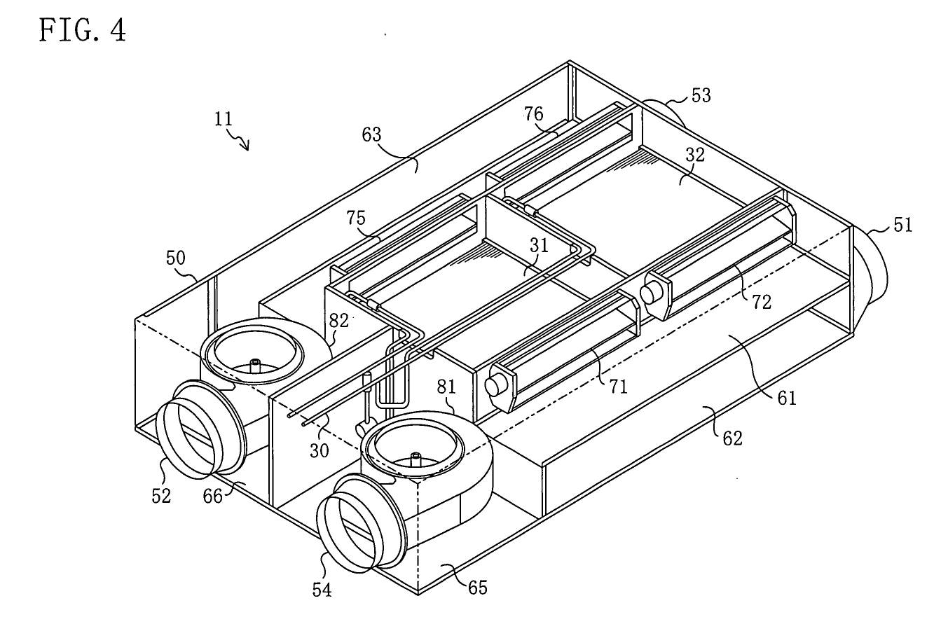

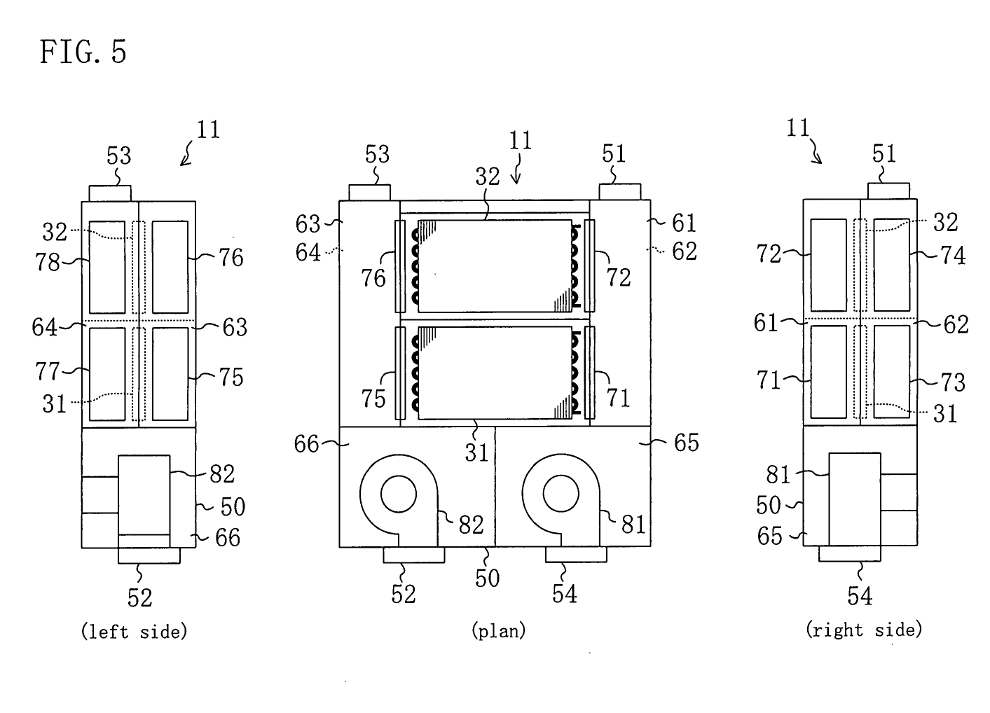

The first and second humidity control units (11, 12) are described with reference to FIGS. 4 and 5. The description is given here only of the structure of the first humidity control unit (11); the first humidity control unit (11) and the second humidity control unit (12) have the same structure. Note that the following terms used here, “upper”, “lower”, “left”, “right”, “front”, “rear” “in front” and “behind”, refer to directionalities when the humidity control units (11, 12) are viewed from in front. The first humidity control unit (11) includes a casing (50). The casing (50) contains the humidity control circuit (30, 40).

The casing (50) is formed in a small-height, flattish, rectangular parallelepiped shape. The front surface of the casing (50) has an exhaust opening (54) open in a right side position thereof and an air supply opening (52) open in a left side position thereof. The rear surface of the casing (50) has an outdoor air suction opening (51) open in a right side position thereof and an indoor air suction opening (53) open in a left side position thereof.

The inner space of the casing (50) is divided into two spaces, a front space and a rear space. The front space in the casing (50) is further divided from left to right into two spaces. Out of the two spaces, the right space forms an exhaust passage (65) and the left space forms an air supply passage (66). The exhaust passage (65) contains an exhaust fan (81) and communicates with the outside of the room through the exhaust opening (54). The air supply passage (66) contains an air supply fan (82) and communicates with the room through the air supply opening (52).

The rear space in the casing (50) is divided from left to right into three spaces. Out of the three spaces, the right-side space is divided from top to bottom into two spaces. The upper space constitutes an upper right passage (61) and the lower space constitutes a lower right passage (62). The upper right passage (61) communicates with the exhaust passage (65). The lower right passage (62) communicates through the outdoor air suction opening (51) with the outside of the room. The upper right passage (61) and the lower right passage (62) constitute an outdoor side passage communicating with the outside atmosphere. On the other hand, the left-side space is divided from top to bottom into two spaces. The upper space constitutes an upper left passage (63) and the lower space constitutes a lower left passage (64). The upper left passage (63) communicates with the air supply passage (66). The lower left passage (64) communicates through the indoor air suction opening (53) with the room. The upper left passage (63) and the lower left passage (64) constitute a room side passage communicating with the room.

Out of the spaces, divided from left to right, of the rear space in the casing (50), the middle space is divided from front to rear. Out of the spaces, divided from front to rear, of the middle space, the front-side space contains the first adsorption heat exchanger (31) and the rear-side space contains the second adsorption heat exchanger (32). The first adsorption heat exchanger (31) and the second adsorption heat exchanger (32) are placed in a substantially horizontal position to further divide the spaces containing themselves from top to bottom.

Each of two partition plates dividing the rear space in the casing (50) from left to right is provided with four on-off dampers (71-78).

The upper part of the right partition plate is provided with a first upper right damper (71) and a second upper right damper (72) juxtaposed to each other and the lower part thereof is provided with a first lower right damper (73) and a second lower right damper (74) juxtaposed to each other. The first upper right damper (71) provides and interrupts communication between the space located above the first adsorption heat exchanger (31) and the upper right passage (61). The second upper right damper (72) provides and interrupts communication between the space above the second adsorption heat exchanger (32) and the upper right passage (61). The first lower right damper (73) provides and interrupts communication between the space located below the first adsorption heat exchanger (31) and the lower right passage (62). The second lower right damper (74) provides and interrupts communication between the space below the second adsorption heat exchanger (32) and the lower right passage (62).

The upper part of the left partition plate is provided with a first upper left damper (75) and a second upper left damper (76) juxtaposed to each other and the lower part thereof is provided with a first lower left damper (77) and a second lower left damper (78) juxtaposed to each other. When the first upper left damper (75) is turned open, the upper left passage (63) communicates with the space located above the first adsorption heat exchanger (31). When the second upper left damper (76) is turned open, the upper left passage (63) communicates with the space located above the second adsorption heat exchanger (32). When the first lower left damper (77) is turned open, the lower left passage (64) communicates with the space located below the first adsorption heat exchanger (31). When the second lower left damper (78) is turned open, the lower left passage (64) communicates with the space located below the second adsorption heat exchanger (32).

—Operational Behavior—

In the above humidity control system (10), each humidity control unit (11, 12) can selectively perform a dehumidification operation and a humidification operation.

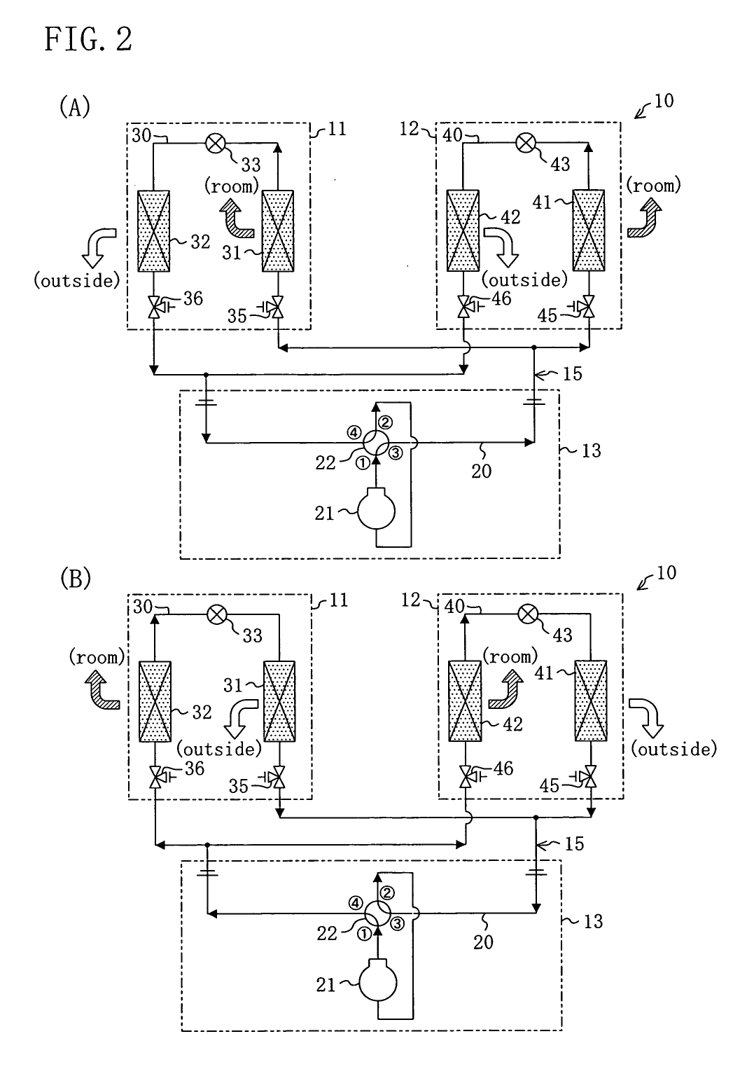

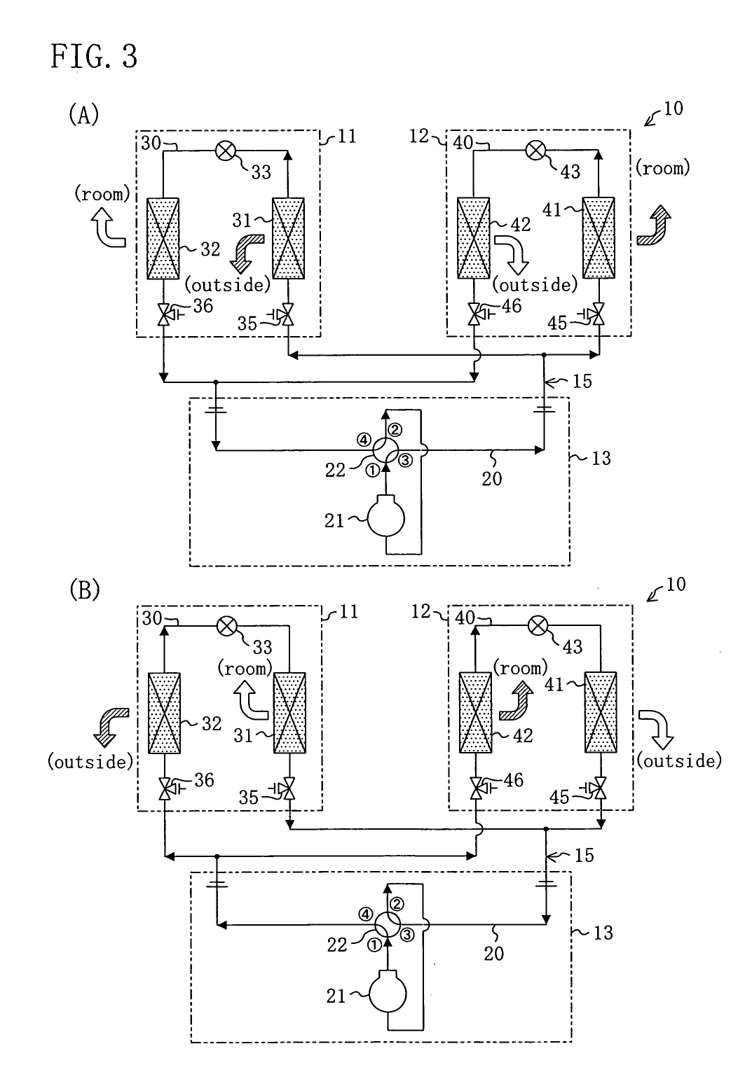

Specifically, as shown in FIG. 1, both the first humidity control unit (11) and the second humidity control unit (12) can perform a dehumidification operation. Alternatively, as shown in FIG. 2, both the first humidity control unit (11) and the second humidity control unit (12) can perform a humidification operation. Alternatively, as shown in FIG. 3, it is possible that one of the first humidity control unit (11) and the second humidity control unit (12) performs a dehumidification operation and the other performs a humidification operation. Note that FIG. 3 shows a state that the first humidity control unit (11) performs a dehumidification operation and the second humidity control unit (12) performs a humidification operation.

<Behavior of Humidity Control System>

As shown in FIGS. 1 to 3, whether each humidity control unit (11, 12) is during dehumidification operation or during humidification operation, the refrigerant circuit (15) alternately repeats a first mode and a second mode.

First, the first mode of the refrigerant circuit (15) is described with reference to FIGS. 1A, 2A and 3A. In the first mode, the outdoor four-way selector valve (22) is set to the first position. Further, in the humidity control circuits (30, 40) of the humidity control units (11, 12), the first adsorption heat exchangers (31, 41) serve as condensers and the second adsorption heat exchangers (32, 42) serve as evaporators.

Specifically, refrigerant discharged from the compressor (21) passes through the outdoor four-way selector valve (22) and is introduced into the humidity control circuits (30, 40) of the humidity control units (11, 12) at their respective first shut-off valves (35, 45). The flows of refrigerant introduced into the humidity control circuits (30, 40) enter the first adsorption heat exchangers (31, 41) and release heat therein to become condensed. In each first adsorption heat exchanger (31, 41), moisture is desorbed from the adsorbent heated by the refrigerant and the desorbed moisture is applied to a second air. The flows of refrigerant condensed in the first adsorption heat exchangers (31, 41) are reduced in pressure during passage through the motor-operated expansion valves (33, 43) and then introduced into the second adsorption heat exchangers (32, 42). In each second adsorption heat exchanger (32, 42), moisture in a first air is adsorbed on the adsorbent and the refrigerant takes heat of adsorption produced during the moisture adsorption and thereby evaporates. The flows of refrigerant evaporated in the second adsorption heat exchangers (32, 42) in the humidity control circuits (30, 40) meet and the combined flow passes through the outdoor four-way selector valve (22), is sucked into the compressor (12) and compressed therein.

Next, the second mode of the refrigerant circuit (15) is described with reference to FIGS. 1B, 2B and 3B. In the second mode, the outdoor four-way selector valve (22) is set to the second position. Further, in the humidity control circuits (30, 40) of the humidity control units (11, 12), the second adsorption heat exchangers (32, 42) serve as condensers and the first adsorption heat exchangers (31, 41) serve as evaporators.

Specifically, refrigerant discharged from the compressor (21) passes through the outdoor four-way selector valve (22) and is introduced into the humidity control circuits (30, 40) of the humidity control units (11, 12) at their respective second shut-off valves (36, 46). The flows of refrigerant introduced into the humidity control circuits (30, 40) enter the second adsorption heat exchangers (32, 42) and release heat therein to become condensed. In each second adsorption heat exchanger (32, 42), moisture is desorbed from the adsorbents heated by the refrigerant and the desorbed moisture is applied to a second air. The flows of refrigerant condensed in the second adsorption heat exchangers (32, 42) are reduced in pressure during passage through the motor-operated expansion valves (33, 43) and then introduced into the first adsorption heat exchangers (31, 41). In each first adsorption heat exchanger (31, 41), moisture in a first air is adsorbed on the adsorbent and the refrigerant takes heat of adsorption produced during the moisture adsorption and thereby evaporates. The flows of refrigerant evaporated in the first adsorption heat exchangers (31, 41) in the humidity control circuits (30, 40) meet and the combined flow passes through the outdoor four-way selector valve (22), is sucked into the compressor (21) and compressed therein.

As described above, in each humidity control unit (11, 12), the first air is dehumidified in one of the first adsorption heat exchanger (31, 41) and the second adsorption heat exchanger (32, 42) which serves as an evaporator while the second air is humidified in the other serving as a condenser. Then, during dehumidification operation, the humidity control unit (11, 12) supplies the dehumidified first air to the room and exhausts the humidified second air to the outside atmosphere (see FIG. 1). On the other hand, during humidification operation, the humidity control unit (11, 12) supplies the humidified second air to the room and exhausts the dehumidified first air to the outside atmosphere (see FIG. 2).

Thus, in each humidity control unit (11, 12), switching between the dehumidifying and humidification operations can be accomplished by changing the destinations of the first and second airs having passed through the adsorption heat exchangers (31, 32, 41, 42). Further, if setting is made so that the destinations of the first and second airs differ between the humidity control units (11, 12), as shown in FIG. 3, it is possible that one humidity control unit (11) performs a dehumidification operation and the other humidity control unit (12) performs a humidification operation.

<Operational Behavior of Humidity Control Unit>

As described above, the first humidity control unit (11) and the second humidity control unit (12) have a common structure and common operational behaviors. Here, a description will be given of the behavior of the first humidity control unit (11), but not the behavior of the second humidity control unit (12). Note that the first humidity control unit (11) sucks air from a first room and supplies humidity-controlled air to the first room, while the second humidity control unit (12) sucks air from a second room and supplies humidity-controlled air to the second room.

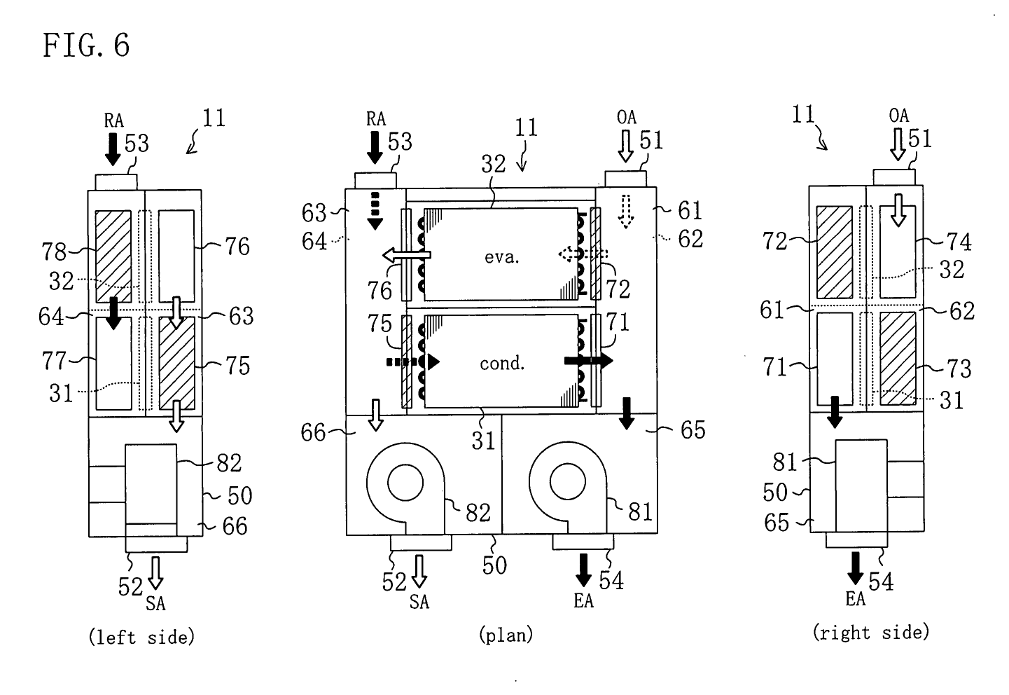

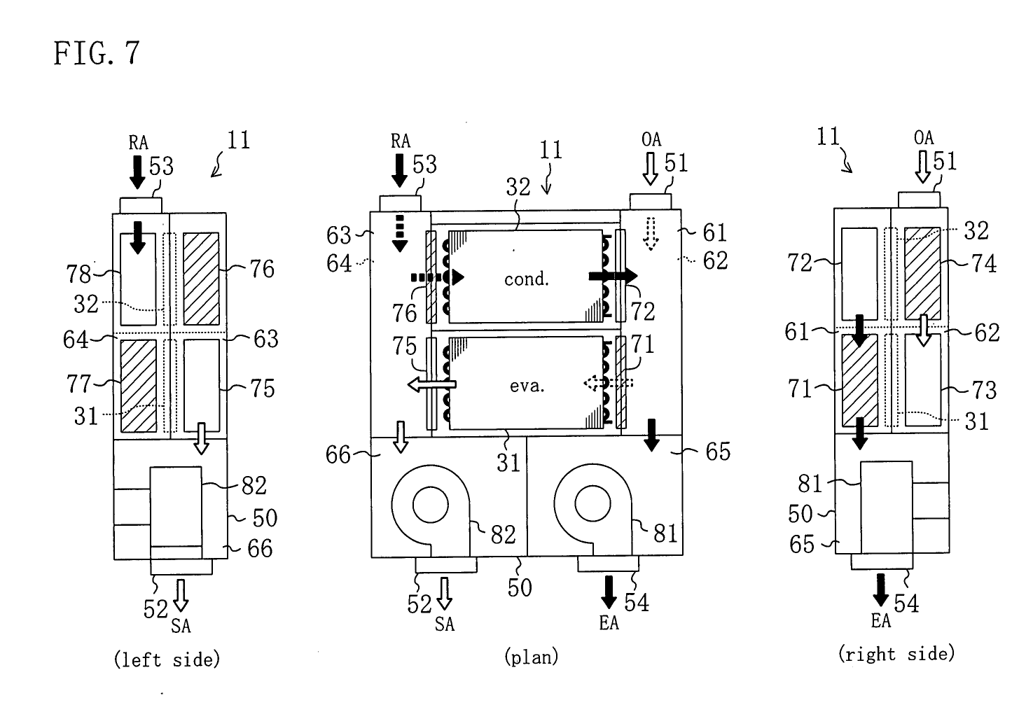

The dehumidification operation of the first humidity control unit (11) is described with reference to FIGS. 6 and 7. When the air supply fan (82) is driven in the dehumidification operation, outdoor air is taken as a first air through the outdoor air suction opening (51) into the casing (50). Further, when the exhaust fan (81) is driven, room air is taken as a second air through the indoor air suction opening (53) into the casing (50).

In the first mode of the dehumidification operation, as described above, the first adsorption heat exchanger (31) serves as a condenser and the second adsorption heat exchanger (32) serves as an evaporator. In this case, the first humidity control unit (11) 10 performs an adsorption action for the second adsorption heat exchanger (32) and a regeneration action for the first adsorption heat exchanger (31).

During the first mode, as shown in FIG. 6, the first upper right damper (71) and the second lower right damper (74) are open and the first lower right damper (73) and the second upper right damper (72) are closed. Further, the first lower left damper (77) and the second upper left damper (76) are open and the first upper left damper (75) and the second lower left damper (78) are closed.

The first air having flowed through the outdoor air suction opening (51) into the lower right passage (62) flows through the second lower right damper (74) into the space below the second adsorption heat exchanger (32) and passes through the second adsorption heat exchanger (32) upward from below. In the second adsorption heat exchanger (32), moisture in the first air is adsorbed by the adsorbent to dehumidify the first air and the heat of adsorption produced during the moisture adsorption is taken by the refrigerant. The first air dehumidified by the second adsorption heat exchanger (32) flows through the second upper left damper (76) into the upper left passage (63), passes through the air supply passage (66) and is then supplied through the air supply opening (52) to the room.

The second air having flowed through the indoor air suction opening (53) into the lower left passage (64) flows through the first lower left damper (77) into the space below the first adsorption heat exchanger (31) and passes through the first adsorption heat exchanger (31) upward from below. In the first adsorption heat exchanger (31), moisture is desorbed from the adsorbent heated by the refrigerant and the desorbed moisture is applied to the second air. The moisture desorbed from the first adsorption heat exchanger (31), together with the second air, flows through the first upper right damper (71) into the upper right passage (61), passes through the exhaust passage (65) and is then exhausted through the exhaust opening (54) to the outside atmosphere.

In the second mode of the dehumidification operation, as described above, the second adsorption heat exchanger (32) serves as a condenser and the first adsorption heat exchanger (31) serves as an evaporator. In this case, the first humidity control unit (11) performs an adsorption action for the first adsorption heat exchanger (31) and a regeneration action for the second adsorption heat exchanger (32). During the second mode, as shown in FIG. 7, the first lower right damper (73) and the second upper right damper (72) are open and the first upper right damper (71) and the second lower right damper (74) are closed. Further, the first upper left damper (75) and the second lower left damper (78) are open and the first lower left damper (77) and the second upper left damper (76) are closed.

The first air having flowed through the outdoor air suction opening (51) into the lower right passage (62) flows through the first lower right damper (73) into the space below the first adsorption heat exchanger (31) and passes through the first adsorption heat exchanger (31) upward from below. In the first adsorption heat exchanger (31), moisture in the first air is adsorbed by the adsorbent to dehumidify the first air and the heat of adsorption produced during the moisture adsorption is taken by the refrigerant. The first air dehumidified by the first adsorption heat exchanger (31) flows through the first upper left damper (75) into the upper left passage (63), passes through the air supply passage (66) and is then supplied through the air supply opening (52) to the room.

The second air having flowed through the indoor air suction opening (53) into the lower left passage (64) flows through the second lower left damper (78) into the space below the second adsorption heat exchanger (32) and passes through the second adsorption heat exchanger (32) upward from below. In the second adsorption heat exchanger (32), moisture is desorbed from the adsorbent heated by the refrigerant and the desorbed moisture is applied to the second air. The moisture desorbed from the second adsorption heat exchanger (32), together with the second air, flows through the second upper right damper (72) into the upper right passage (61), passes through the exhaust passage (65) and is then exhausted through the exhaust opening (54) to the outside atmosphere.

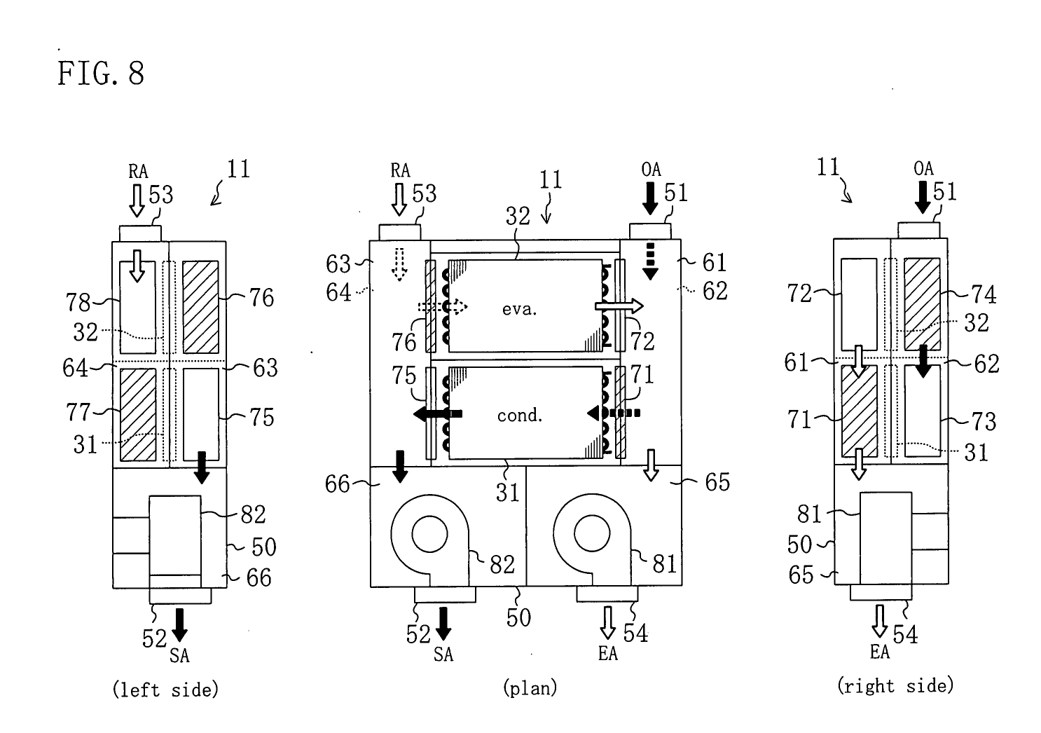

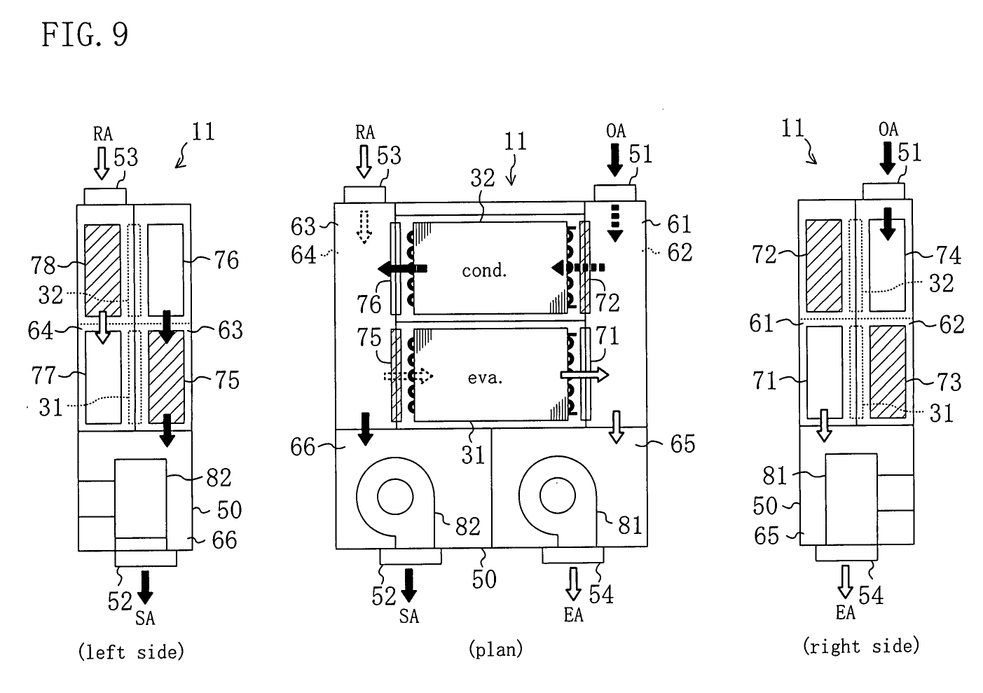

The humidification operation of the first humidity control unit (11) is described with reference to FIGS. 8 and 9. When the air supply fan (82) is driven in the humidification operation, outdoor air is taken as a second air through the outdoor air suction opening (51) into the casing (50). Further, when the exhaust fan (81) is driven, room air is taken as a first air through the indoor air suction opening (53) into the casing (50).

In the first mode of the humidification operation, as described above, the first adsorption heat exchanger (31) serves as a condenser and the second adsorption heat exchanger (32) serves as an evaporator. In this case, the first humidity control unit (11) performs an adsorption action for the second adsorption heat exchanger (32) and a regeneration action for the first adsorption heat exchanger (31).

During the first mode, as shown in FIG. 8, the first lower right damper (73) and the second upper right damper (72) are open and the first upper right damper (71) and the second lower right damper (74) are closed. Further, the first upper left damper (75) and the second lower left damper (78) are open and the first lower left damper (77) and the second upper left damper (76) are closed.

The first air having flowed through the indoor air suction opening (53) into the lower left passage (64) flows through the second lower left damper (78) into the space below the second adsorption heat exchanger (32) and passes through the second adsorption heat exchanger (32) upward from below. In the second adsorption heat exchanger (32), moisture in the first air is adsorbed by the adsorbent to dehumidify the first air and the heat of adsorption produced during the moisture adsorption is taken by the refrigerant. The first air dried by the second adsorption heat exchanger (32) flows through the second upper right damper (72) into the upper right passage (61), passes through the exhaust passage (65) and is then exhausted through the exhaust opening (54) to the outside atmosphere.

The second air having flowed through the outdoor air suction opening (51) into the lower right passage (62) flows through the first lower right damper (73) into the space below the first adsorption heat exchanger (31) and passes through the first adsorption heat exchanger (31) upward from below. In the first adsorption heat exchanger (31), moisture is desorbed from the adsorbent heated by refrigerant and the desorbed moisture is applied to the second air. The second air humidified by the first adsorption heat exchanger (31) flows through the first upper left damper (75) into the upper left passage (63), passes through the air supply passage (66) and is then supplied through the air supply opening (52) to the room.

In the second mode of the humidification operation, as described above, the second adsorption heat exchanger (32) serves as a condenser and the first adsorption heat exchanger (31) serves as an evaporator. In this case, the first humidity control unit (11) performs an adsorption action for the first adsorption heat exchanger (31) and a regeneration action for the second adsorption heat exchanger (32).

During the second mode, as shown in FIG. 9, the first upper right damper (71) and the second lower right damper (74) are open and the first lower right damper (73) and the second upper right damper (72) are closed. Further, the first lower left damper (77) and the second upper left damper (76) are open and the first upper left damper (75) and the second lower left damper (78) are closed.

The first air having flowed through the indoor air suction opening (53) into the lower left passage (64) flows through the first lower left damper (77) into the space below the first adsorption heat exchanger (31) and passes through the first adsorption heat exchanger (31) upward from below. In the first adsorption heat exchanger (31), moisture in the first air is adsorbed by the adsorbent to dehumidify the first air and the heat of adsorption produced during the moisture adsorption is taken by the refrigerant. The first air dried by the first adsorption heat exchanger (31) flows through the first upper right damper (71) into the upper right passage (61), passes through the exhaust passage (65) and is then exhausted through the exhaust opening (54) to the outside atmosphere.

The second air having flowed through the outdoor air suction opening (51) into the lower right passage (62) flows through the second lower right damper (74) into the space below the second adsorption heat exchanger (32) and passes through the second adsorption heat exchanger (32) upward from below. In the second adsorption heat exchanger (32), moisture is desorbed from the adsorbent heated by refrigerant and the desorbed moisture is applied to the second air. The second air humidified by the second adsorption heat exchanger (32) flows through the second upper left damper (76) into the upper left passage (63), passes through the air supply passage (66) and is then supplied through the air supply opening (52) to the room.

### Effects of Embodiment 1

In the humidity control system (10) of this embodiment, each humidity control unit (11, 12) is configured to be able to individually select whether it performs a dehumidification operation or a humidification operation. Therefore, when the humidity control units (11, 12) supply humidity-controlled air to different rooms, each humidity control unit (11, 12) can select either a dehumidification operation or a humidification operation according to the circumstances of the associated room. Specifically, under a circumstance where some rooms require dehumidification and the others require humidification, dehumidification operation can be carried out in the humidity control unit (11, 12) for supplying air to the rooms requiring dehumidification, while humidification operation can be carried out in the humidity control unit (11, 12) or supplying air to the rooms requiring humidification. Therefore, according to this embodiment, each humidity control unit (11, 12) can perform an operation according to the request from the associated room, which provides a humidity control system (10) convenient for humidity control for a plurality of rooms

Furthermore, according to this embodiment, since the adsorption heat exchangers (31, 32, 41, 42) connected in the refrigerant circuit (15) carry adsorbents, the adsorbents can be efficiently heated or cooled by the refrigerant in the refrigerant circuit (15). As a result, the amount of water vapor transferred between the adsorbents and air can be increased, thereby providing enhanced performance of the humidity control units (11, 12) or downsized humidity control units (11, 12).

Furthermore, each of the humidity control units (11, 12) in this embodiment is configured to operate in batches so that one of the first and second adsorption heat exchangers (31, 32, 41, 42) adsorbs water vapor while the other is regenerated. Therefore, according to this embodiment, each humidity control unit (11, 12) can continuously produce a dehumidified first air and a humidified second air and continuously supply the obtained first or second air to the room.

Furthermore, in each humidity control unit (11, 12) in this embodiment, out of the first and second adsorption heat exchangers (31, 32, 41, 42), one for dehumidifying the first air serves as an evaporator and the other for humidifying the second air serves as a condenser. Therefore, in the adsorption heat exchanger (31, 32, 41, 42) serving as an evaporator, the adsorbent is cooled by the refrigerant in the refrigerant circuit (15) to promote the adsorption of water vapor in the air on the adsorbent. On the other hand, in the adsorption heat exchanger (31, 32, 41, 42) serving as a condenser, the adsorbent is heated by the refrigerant in the refrigerant circuit (15) to promote the desorption of water vapor from the adsorbent. Therefore, according to this embodiment, both the adsorption of water vapor on the adsorbent and desorption of water vapor from the adsorbent can be promoted, which provides enhanced performance of the humidity control units (11, 12) or downsized humidity control units (11, 12).

Moreover, in this embodiment, the outdoor four-way selector valve (22) disposed in the outdoor unit (13) inverts the flow direction of refrigerant in all the humidity control circuits (30, 40). In other words, only with the outdoor four-way selector valve (22) in the outdoor unit (13), switching of the flow direction of refrigerant in the humidity control circuits (30, 40) associated with mode switching is implemented. Therefore, according to this embodiment, the number of parts disposed in the refrigerant circuit (15) can be minimized, which provides a simplified humidity control system (10). Moreover, the outdoor four-way selector valve (22) selects the ports with a relatively high frequency, for example, about once in every four to five minutes, and therefore has a high possibility of causing noises. To cope with this, in this embodiment, the outdoor four-way selector valve (22) is disposed in the outdoor unit (13) installed outside the house. Therefore, this embodiment can avoid troubles with noises produced in association with the actuation of the outdoor four-way selector valve (22).

### Modification 1 of Embodiment 1

In the above-mentioned dehumidification operation of each humidity control unit (11, 12), the outdoor air is taken in as a first air and supplied to the room while the room air is taken in as a second air and exhausted to the outside atmosphere. Thus, the room is ventilated while the dehumidified first air is supplied to the room.

Unlike the above, in the dehumidification operation of each humidity control unit (11, 12), only the supply of dehumidified first air may be carried out without room ventilation. A description is given of the behaviors of the humidity control units (11, 12) during the dehumidification operation, taking the first humidity control unit (11) as an example.

When the air supply fan (82) is driven in the dehumidification operation, room air is taken as a first air through the indoor air suction opening (53) into the casing (50). Further, when the exhaust fan (81) is driven, outdoor air is taken as a second air through the outdoor air suction opening (51) into the casing (50). Also in this dehumidification operation, the first humidity control unit (11) alternately repeats the first mode and second mode.

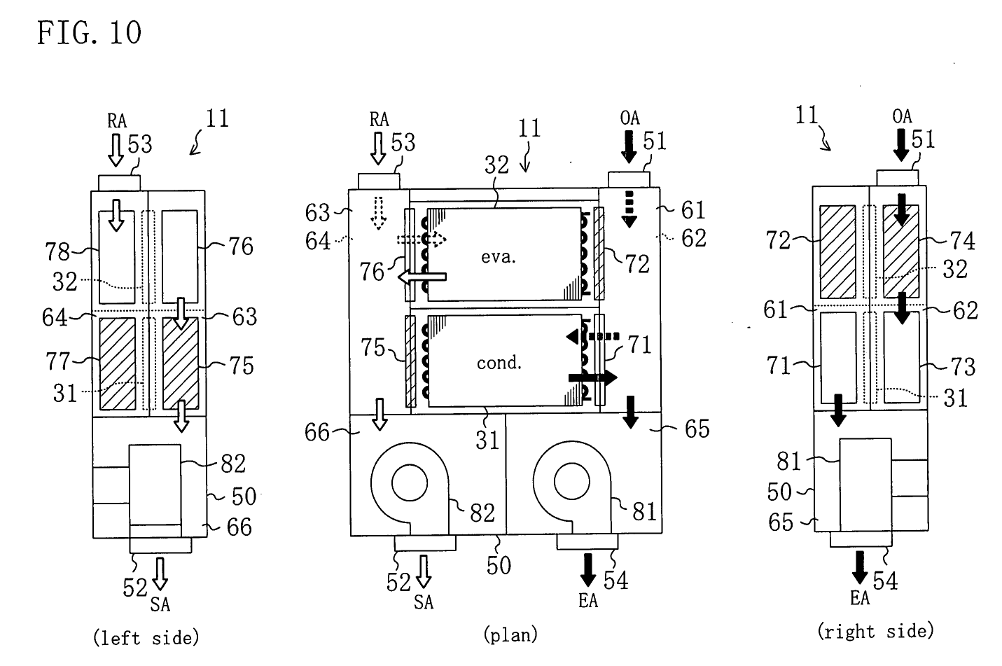

During the first mode, as shown in FIG. 10, the first upper right damper (71) and the first lower right damper (73) are open and the second upper right damper (72) and the second lower right damper (74) are closed. Further, the second upper left damper (76) and the second lower left damper (78) are open and the first upper left damper (75) and the first lower left damper (77) are closed. Furthermore, during the first mode, the first adsorption heat exchanger (31) serves as a condenser and the second adsorption heat exchanger (32) serves as an evaporator.

The first air having flowed through the indoor air suction opening (53) into the lower left passage (64) flows through the second lower left damper (78) into the second adsorption heat exchanger (32) and is dehumidified during passage through the second adsorption heat exchanger (32). The dehumidified first air flows through the second upper left damper (76) into the upper left passage (63), passes through the air supply passage (66) and is then supplied through the air supply opening (52) to the room. The second air having flowed through the outdoor air suction opening (51) into the lower right passage (62) flows through the first lower right damper (73) into the first adsorption heat exchanger (31) and is given moisture desorbed from the first adsorption heat exchanger (31). The moisture-given second air flows through the first upper right damper (71) into the upper right passage (61), passes through the exhaust passage (65) and is then exhausted through the exhaust opening (54) to the outside atmosphere.

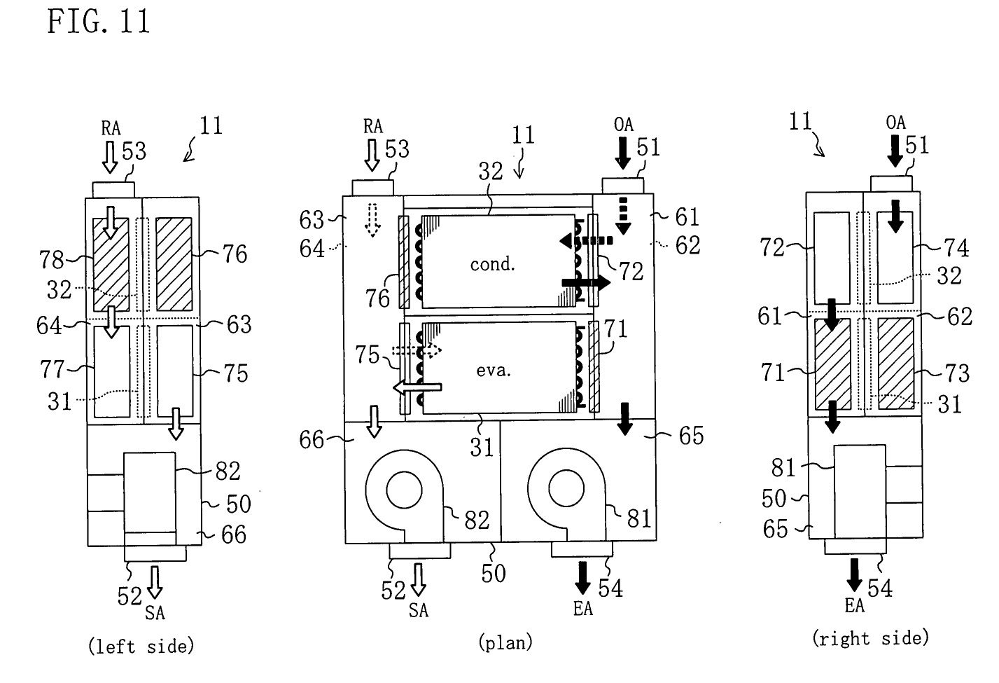

During the second mode, as shown in FIG. 11, the second upper right damper (72) and the second lower right damper (74) are open and the first upper right damper (71) and the first lower right damper (73) are closed. Further, the first upper left damper (75) and the first lower left damper (77) are open and the second upper left damper (76) and the second lower left damper (78) are closed. Furthermore, during the second mode, the second adsorption heat exchanger (32) serves as a condenser and the first adsorption heat exchanger (31) serves as an evaporator.

The first air having flowed through the indoor air suction opening (53) into the lower left passage (64) flows through the first lower left damper (77) into the first adsorption heat exchanger (31) and is dehumidified during passage through the first adsorption heat exchanger (31). The dehumidified first air flows through the first upper left damper (75) into the upper left passage (63), passes through the air supply passage (66) and is then supplied through the air supply opening (52) to the room. The second air having flowed through the outdoor air suction opening (51) into the lower right passage (62) flows through the second lower right damper (74) into the second adsorption heat exchanger (32) and is given moisture desorbed from the second adsorption heat exchanger (32). The moisture-given second air flows through the second upper right damper (72) into the upper right passage (61), passes through the exhaust passage (65) and is then exhausted through the exhaust opening (54) to the outside atmosphere.

### Modification 2 of Embodiment 1

In the above-mentioned humidification operation of each humidity control unit (11, 12), the outdoor air is taken in as a second air and supplied to the room while the room air is taken in as a first air and exhausted to the outside atmosphere. Thus, the room is ventilated while the humidified second air is supplied to the room.

Unlike the above, in the humidification operation of each humidity control unit (11, 12), only the supply of humidified second air may be carried out without room ventilation. A description is given of the behaviors of the humidity control units (11, 12) during the humidification operation, taking the first humidity control unit (11) as an example.

When the air supply fan (82) is driven in the humidification operation, room air is taken as a second air through the indoor air suction opening (53) into the casing (50). Further, when the exhaust fan (81) is driven, outdoor air is taken as a first air through the outdoor air suction opening (51) into the casing (50). Also in this humidification operation, the first humidity control unit (11) alternately repeats the first mode and second mode.

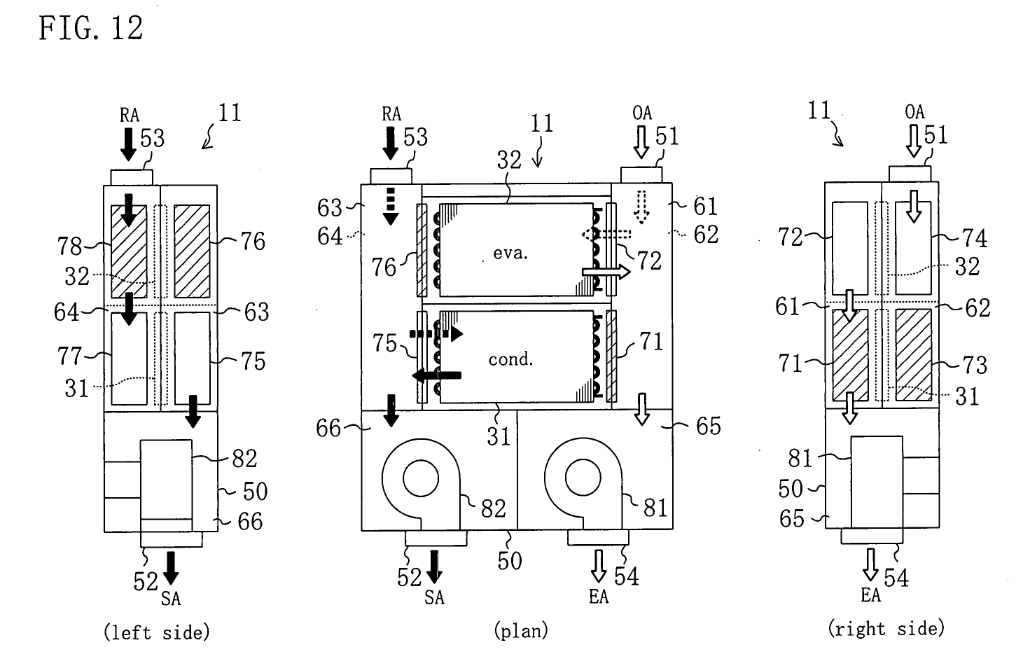

During the first mode, as shown in FIG. 12, the second upper right damper (72) and the second lower right damper (74) are open and the first upper right damper (71) and the first lower right damper (73) are closed. Further, the first upper left damper (75) and the first lower left damper (77) are open and the second upper left damper (76) and the second lower left damper (78) are closed. Furthermore, during the first mode, the first adsorption heat exchanger (31) serves as a condenser and the second adsorption heat exchanger (32) serves as an evaporator.

The first air having flowed through the outdoor air suction opening (51) into the lower right passage (62) flows through the second lower right damper (74) into the second adsorption heat exchanger (32) and is dried during passage through the second adsorption heat exchanger (32). The dried first air flows through the second upper right damper (72) into the upper right passage (61), passes through the exhaust passage (65) and is then exhausted through the exhaust opening (54) to the outside atmosphere.

The second air having flowed through the indoor air suction opening (53) into the lower left passage (64) flows through the first lower left damper (77) into the first adsorption heat exchanger (31) and is humidified during passage through the first adsorption heat exchanger (31). The humidified second air flows through the first upper left damper (75) into the upper left passage (63), passes through the air supply passage (66) and is then supplied through the air supply opening (52) to the room.

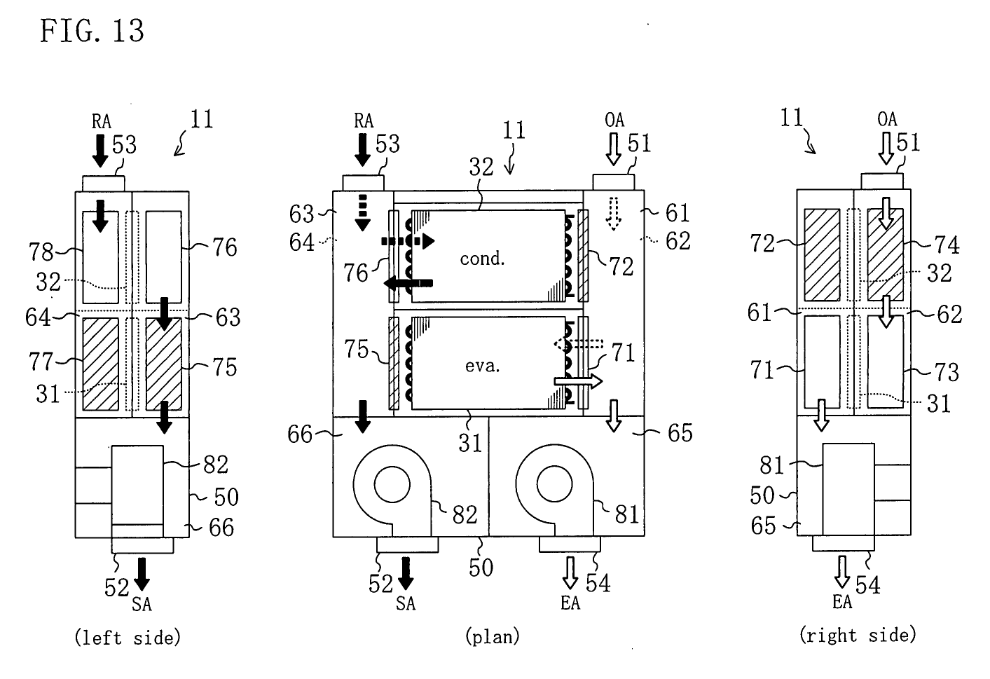

During the second mode, as shown in FIG. 13, the first upper right damper (71) and the first lower right damper (73) are open and the second upper right damper (72) and the second lower right damper (74) are closed. Further, the second upper left damper (76) and the second lower left damper (78) are open and the first upper left damper (75) and the first lower left damper (77) are closed. Furthermore, during the second mode, the second adsorption heat exchanger (32) serves as a condenser and the first adsorption heat exchanger (31) serves as an evaporator.

The first air having flowed through the outdoor air suction opening (51) into the lower right passage (62) flows through the first lower right damper (73) into the first adsorption heat exchanger (31) and is dried during passage through the first adsorption heat exchanger (31). The dried first air flows through the first upper right damper (71) into the upper right passage (61), passes through the exhaust passage (65) and is then exhausted through the exhaust opening (54) to the outside atmosphere.

The second air having flowed through the indoor air suction opening (53) into the lower left passage (64) flows through the second lower left damper (78) into the second adsorption heat exchanger (32) and is humidified during passage through the second adsorption heat exchanger (32). The humidified second air flows through the second upper left damper (76) into the upper left passage (63), passes through the air supply passage (66) and is then supplied through the air supply opening (52) to the room.

### Modification 3 of Embodiment 1

Each humidity control unit (11, 12) may perform the operation of only carrying out air supply from the outside to the room as a dehumidification operation or a humidification operation. A description is given of the behaviors of the humidity control units (11, 12) both during dehumidification operation for air supply only and during humidification operation for air supply only, taking the first humidity control unit (11) as an example.

When the air supply fan (82) and the exhaust fan (81) are driven in each of the dehumidification operation and humidification operation for air supply only, only outdoor air is taken through the outdoor air suction opening (51) into the casing (50). Further, in each of the dehumidification operation and humidification operation for air supply only, a first mode in which the first adsorption heat exchanger (31) serves as a condenser and the second adsorption heat exchanger (32) serves as an evaporator and a second mode in which the second adsorption heat exchanger (32) serves as a condenser and the first adsorption heat exchanger (31) serves as an evaporator are repeatedly alternated.

First, the dehumidification operation for air supply only is described. Part of the outdoor air taken into the casing (50) is introduced as a first air into the adsorption heat exchanger (31, 32) serving as an evaporator, and the rest is introduced as a second air into the adsorption heat exchanger (31, 32) serving as a condenser. Then, the first humidity control unit (11) supplies to the room the first air dehumidified by one of the two adsorption heat exchangers (31, 32) serving as an evaporator and exhausts to the outside atmosphere the second air humidified by the other serving as a condenser.

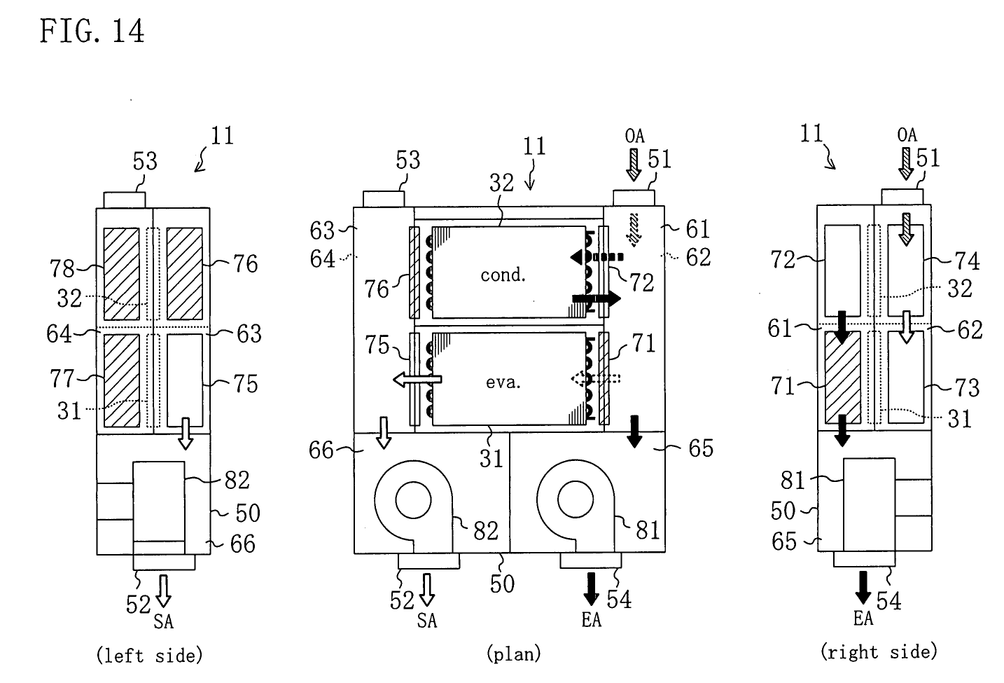

For example, during the second mode of the dehumidification operation, as shown in FIG. 14, the second upper right damper (72), the first lower right damper (73) and the second lower right damper (74) are open and the first upper right damper (71) is closed. Further, the first upper left damper (75) is open and the second upper left damper (76), the first lower left damper (77) and the second lower left damper (78) are closed. In the casing (50), the first air flows sequentially through the first lower right damper (73), the first adsorption heat exchanger (31) and the first upper left damper (75) and is supplied through the air supply opening (52) to the room. On the other hand, the second air flows sequentially through the second lower right damper (74), the second adsorption heat exchanger (32) and the second upper right damper (72) and is exhausted through the exhaust opening (54) to the outside atmosphere.

Next, the humidification operation for air supply only is described. Part of the outdoor air taken into the casing (50) is introduced as a first air into the adsorption heat exchanger (31, 32) serving as an evaporator, and the rest is introduced as a second air into the adsorption heat exchanger (31, 32) serving as a condenser. Then, the first humidity control unit (11) exhausts to the outside atmosphere the first air dehumidified by one of the two adsorption heat exchangers (31, 32) serving as an evaporator and supplies to the room the second air humidified by the other serving as a condenser.

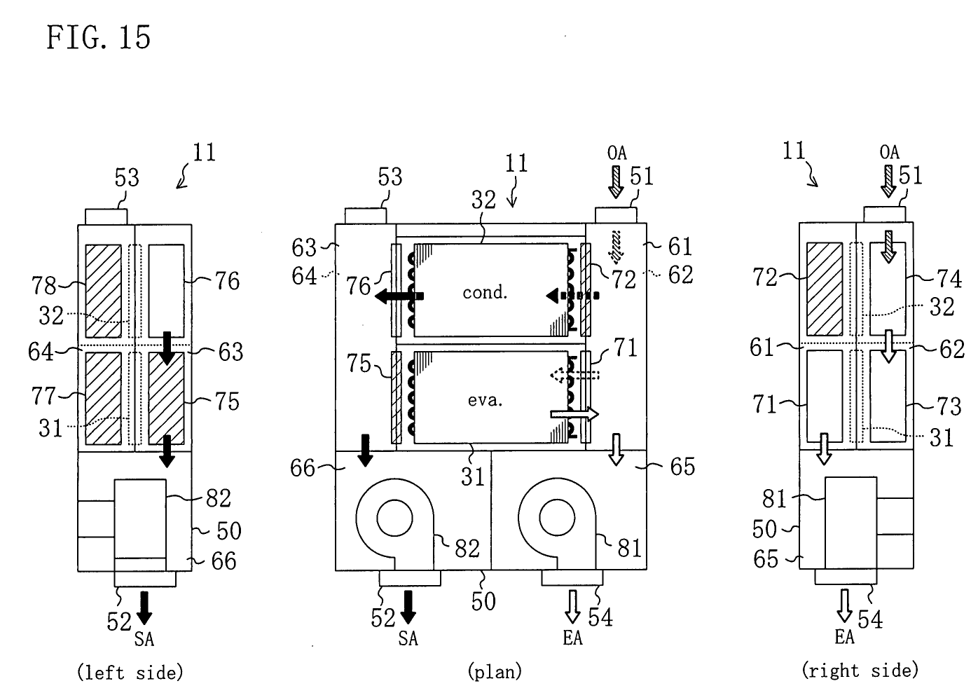

For example, during the second mode of the humidification operation, as shown in FIG. 15, the first upper right damper (71), the first lower right damper (73) and the second lower right damper (74) are open and the second upper right damper (72) is closed. Further, the second upper left damper (76) is open and the first upper left damper (75), the first lower left damper (77) and the second lower left damper (78) are closed. In the casing (50), the first air flows sequentially through the first lower right damper (73), the first adsorption heat exchanger (31) and the first upper right damper (71) and is exhausted through the exhaust opening (54) to the outside atmosphere. On the other hand, the second air flows sequentially through the second lower right damper (74), the second adsorption heat exchanger (32) and the second upper left damper (76) and is supplied through the air supply opening (52) to the room.

### Modification 4 of Embodiment 1

Each humidity control unit (11, 12) may perform the operation of only carrying out exhaust from the room to the outside as a dehumidification operation or a humidification operation. A description is given of the behaviors of the humidity control units (11, 12) both during dehumidification operation for exhaust only and during humidification operation for exhaust only, taking the first humidity control unit (11) as an example.

When the air supply fan (82) and the exhaust fan (81) are driven in each of the dehumidification operation and humidification operation for exhaust only, only room air is taken through the indoor air suction opening (53) into the casing (50). Further, in each of the dehumidification operation and humidification operation for exhaust only, a first mode in which the first adsorption heat exchanger (31) serves as a condenser and the second adsorption heat exchanger (32) serves as an evaporator and a second mode in which the second adsorption heat exchanger (32) serves as a condenser and the first adsorption heat exchanger (31) serves as an evaporator are repeatedly alternated.

First, the dehumidification operation for exhaust only is described. Part of the room air taken into the casing (50) is introduced as a first air into the adsorption heat exchanger (31, 32) serving as an evaporator, and the rest is introduced as a second air into the adsorption heat exchanger (31, 32) serving as a condenser. Then, the first humidity control unit (11) supplies to the room the first air dehumidified by one of the two adsorption heat exchangers (31, 32) serving as an evaporator and exhausts to the outside atmosphere the second air humidified by the other serving as a condenser.

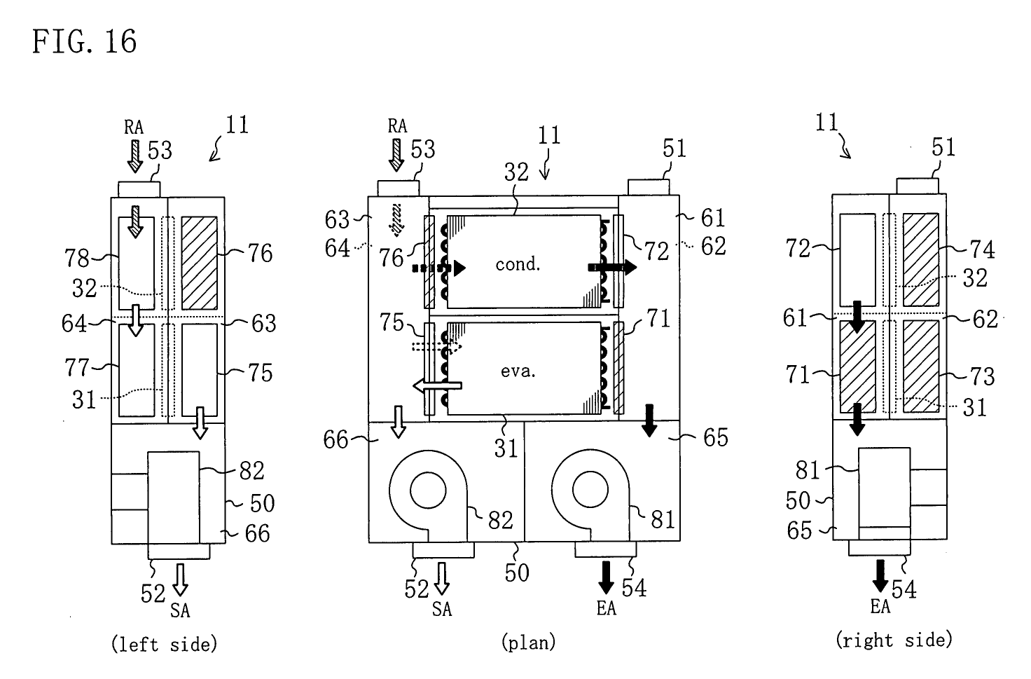

For example, during the second mode of the dehumidification operation, as shown in FIG. 16, the second upper right damper (72) is open and the first upper right damper (71), the first lower right damper (73) and the second lower right damper (74) are is closed. Further, the first upper left damper (75), the first lower left damper (77) and the second lower left damper (78) are open and the second upper left damper (76) is closed. In the casing (50), the first air flows sequentially through the first lower left damper (77), the first adsorption heat exchanger (31) and the first upper left damper (75) and is supplied through the air supply opening (52) to the room. On the other hand, the second air flows sequentially through the second lower left damper (78), the second adsorption heat exchanger (32) and the second upper right damper (72) and is exhausted through the exhaust opening (54) to the outside atmosphere.

Next, the humidification operation for exhaust only is described. Part of the room air taken into the casing (50) is introduced as a first air into the adsorption heat exchanger (31, 32) serving as an evaporator, and the rest is introduced as a second air into the adsorption heat exchanger (31, 32) serving as a condenser. Then, the first humidity control unit (11) exhausts to the outside atmosphere the first air dehumidified by one of the two adsorption heat exchangers (31, 32) serving as an evaporator and supplies to the room the second air humidified by the other serving as a condenser.

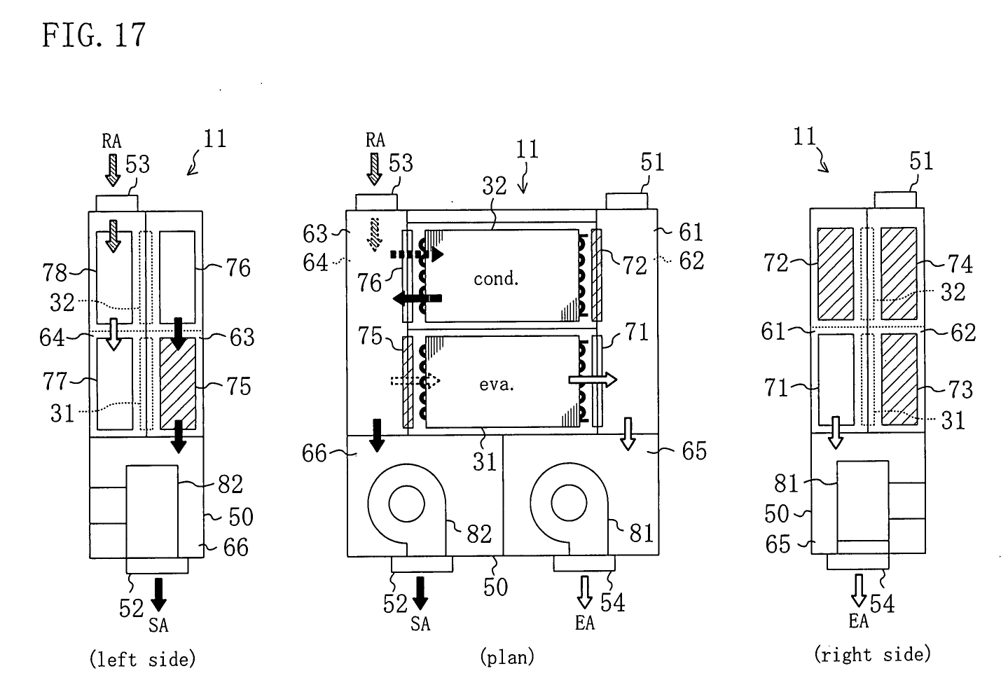

For example, during the second mode of the humidification operation, as shown in FIG. 17, the first upper right damper (71) is open and the second upper right damper (72), the first lower right damper (73) and the second lower right damper (74) are closed. Further, the second upper left damper (76), the first lower left damper (77) and the second lower left damper (78) are open and the first upper left damper (75) is closed. In the casing (50), the first air flows sequentially through the first lower left damper (77), the first adsorption heat exchanger (31) and the first upper right damper (71) and is exhausted through the exhaust opening (54) to the outside atmosphere. On the other hand, the second air flows sequentially through the second lower left damper (78), the second adsorption heat exchanger (32) and the second upper left damper (76) and is supplied through the air supply opening (52) to the room.

### Modification 5 of Embodiment 1

In the humidity control system (10), each humidity control unit (11, 12) may perform the following operation.

As described above, each humidity control unit (11, 12) carries out air supply from the outside to the room and exhaust from the room to the outside during dehumidification operation and humidification operation. In these cases, the amount of air supply to the room is essentially set to be equal to the amount of exhaust from the room. However, both the amounts may be set at different values. For example, if it is desired to prevent the outdoor air from entering the room as with drafts, the amount of air supply is set to be larger than the amount of exhaust in order to bring the room under a positive pressure. On the other hand, if it is desired to prevent the room air from leaking out to the outside, the amount of exhaust is set to be larger than the amount of air supply in order to bring the room under a negative pressure.

Furthermore, each humidity control unit (11, 12) may carry out a simple ventilation operation by fully closing the motor-operated expansion valve (33, 43) to shut off the communication of refrigerant through the humidity control circuit (30, 40) and, in this state, driving the air supply fan (82) and the exhaust fan (81) to provide ventilation only. For example, humidity control on the room is often unnecessary in the middle seasons such as spring and autumn, whereas room ventilation is necessary throughout the year. In such a season when humidity control is not needed, a simple ventilation operation provides reduced power consumption of the humidity control system (10).

Furthermore, each humidity control unit (11, 12) may perform an air-conditioning operation for supplying, to the room, air in which the humidity is not controlled but the temperature only is controlled. In the air conditioning of each humidity control unit (11, 12), the open/close positions of the dampers (71-78) may be set so that the air having passed through one of the two adsorption heat exchangers (31, 32, 41, 42) serving as an evaporator is supplied to the room and the air having passed through the other serving as a condenser is exhausted to the outside atmosphere. In this case, the air cooled by the adsorption heat exchanger (31, 32, 41, 42) is supplied to the room thereby cooling it. On the other hand, the open/close positions of the dampers (71-78) may be set so that the air having passed through one of the two adsorption heat exchangers (31, 32, 41, 42) serving as a condenser is supplied to the room and the air having passed through the other serving as an evaporator is exhausted to the outside atmosphere. In this case, the air heated by the adsorption heat exchanger (31, 32, 41, 42) is supplied to the room thereby heating it.

### Embodiment 2 of the Invention

A description is given of Embodiment 2 of the invention. This embodiment differs from the humidity control system (10) of Embodiment 1 in the configurations of the outdoor circuit (20) and each humidity control circuit (30, 40). Further, in connection with the differences in the configurations of the outdoor circuit (20) and each humidity control circuit (30, 40), the humidity control system (10) of this embodiment also differs from Embodiment 1 in the configuration of the refrigerant circuit (15). Here, the humidity control system (10) is described in terms of different points from Embodiment 1.

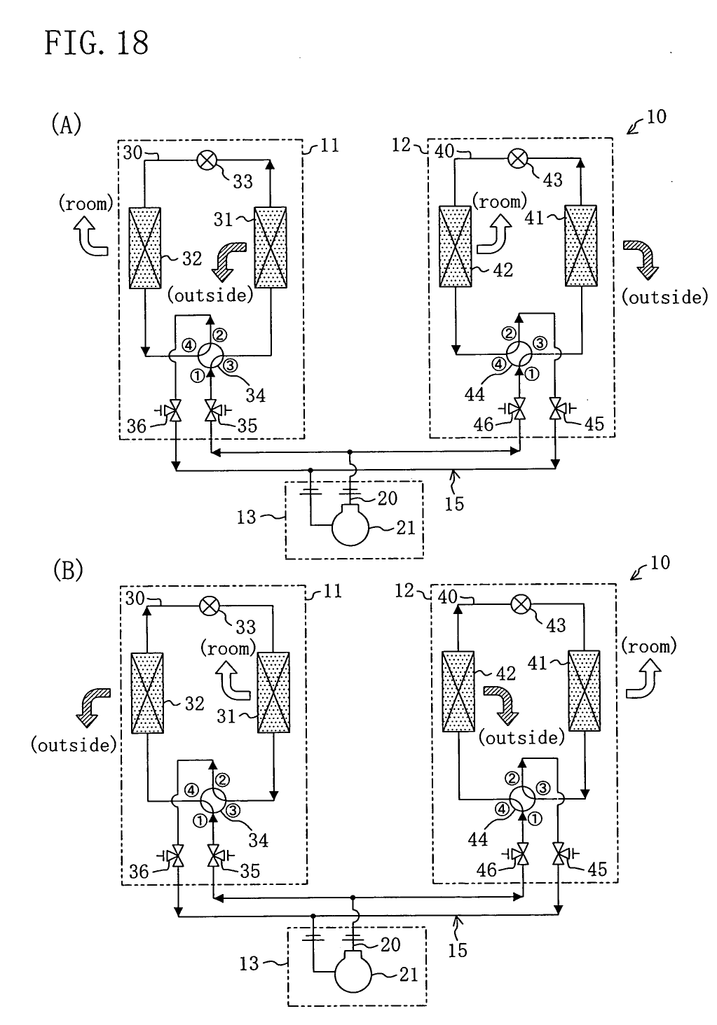

As shown in FIG. 18, the humidity control circuits (30, 40) in this embodiment are additionally provided with their respective humidity control four-way selector valves (34, 44). These humidity control four-way selector valves (34, 44) each constitute an inversion mechanism for inverting the flow direction of refrigerant in the associated humidity control circuit (30, 40).

In each humidity control circuit (30, 40), the first shut-off valve (35, 45) is connected to the first port of the humidity control four-way selector valve (34, 44) and the second shut-off valve (36, 46) is connected to the second port of the humidity control four-way selector valve (34, 44). Further, in each humidity control circuit (30, 40), the first adsorption heat exchanger (31, 41), the motor-operated expansion valve (33, 43) and the second adsorption heat exchanger (32, 42) are arranged in order from the third port toward the fourth port of the humidity control four-way selector valve (34, 44).

The humidity control four-way selector valve (34, 44) in each humidity control circuit (30, 40) switches between a first position in which the first and third ports communicate with each other and the second and fourth ports communicate with each other (the position shown in FIG. 18A) and a second position in which the first and fourth ports communicate with each other and the second and third ports communicate with each other (the position shown in FIG. 18B).

On the other hand, the outdoor circuit (20) in this embodiment includes only a compressor (21). The end of the outdoor circuit (20) located toward the discharge side of the compressor (21) is connected through connection pipes to the first shut-off valves (35, 45) of the humidity control circuits (30, 40). The end of the outdoor circuit (20) located toward the suction side of the compressor (21) is connected through other connection pipes to the second shut-off valves (36, 46) of the humidity control circuits (30, 40).

—Operational Behavior—

In the above humidity control system (10), each humidity control unit (11, 12) can selectively perform a dehumidification operation and a humidification operation.

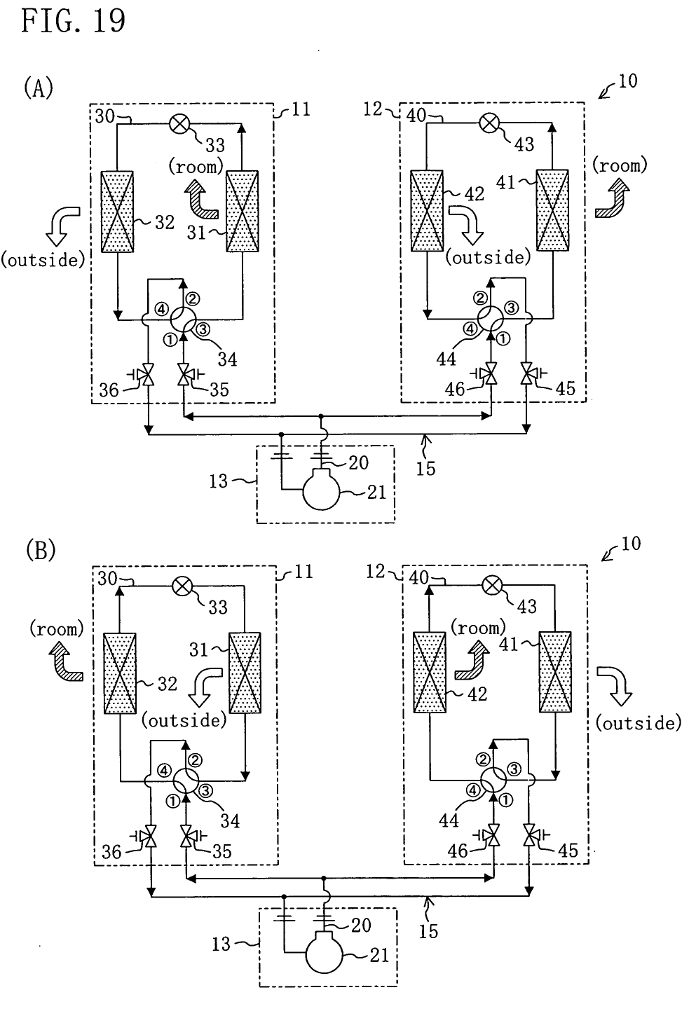

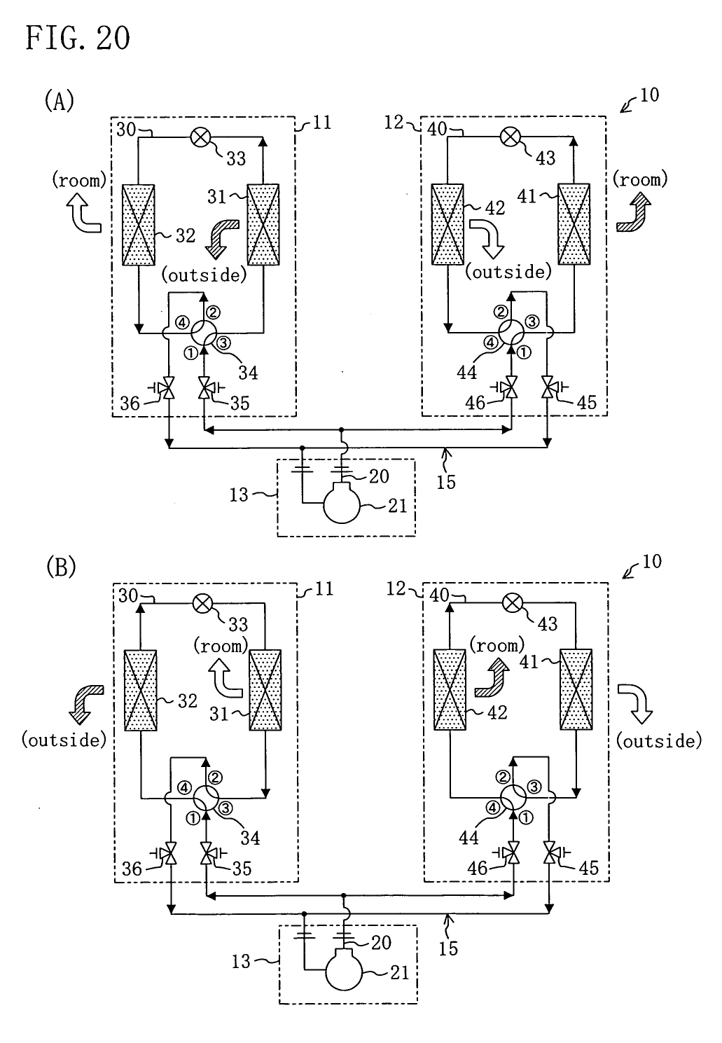

Specifically, as shown in FIG. 18, both the first humidity control unit (11) and the second humidity control unit (12) can perform a dehumidification operation. Alternatively, as shown in FIG. 19, both the first humidity control unit (11) and the second humidity control unit (12) can perform a humidification operation. Alternatively, as shown in FIG. 20, it is possible that one of the first humidity control unit (11) and the second humidity control unit (12) performs a dehumidification operation and the other performs a humidification operation. Note that FIG. 20 shows a state that the first humidity control unit (11) performs a dehumidification operation and the second humidity control unit (12) performs a humidification operation.

<Behavior of Humidity Control System>

As shown in FIGS. 18 to 20, whether each humidity control unit (11, 12) is during dehumidification operation or during humidification operation, the refrigerant circuit (15) alternately repeats a first mode and a second mode.

First, the first mode of the refrigerant circuit (15) is described with reference to FIGS. 18A, 19A and 20A. In the first mode, the humidity control four-way selector valves (34, 44) in the humidity control units (11, 12) are set to the first position. Further, in the humidity control circuits (30, 40) of the humidity control units (11, 12), the first adsorption heat exchangers (31, 41) serve as condensers and the second adsorption heat exchangers (32, 42) serve as evaporators. Specifically, refrigerant discharged from the compressor (21) and distributed to each humidity control circuit (30, 40) condenses in the first adsorption heat exchanger (31, 41), is reduced in pressure during passage through the motor-operated expansion valve (33, 43), evaporates in the second adsorption heat exchanger (32, 42), is then sucked into the compressor (21) and compressed therein. Further, the second air is humidified in each first adsorption heat exchanger (31, 41) serving as a condenser, while the first air is dehumidified in each second adsorption heat exchanger (32, 42) serving as an evaporator.

Next, the second mode of the refrigerant circuit (15) is described with reference to FIGS. 18B, 19B and 20B. In the second mode, the humidity control four-way selector valves (34, 44) in the humidity control units (11, 12) are set to the second position. Further, in the humidity control circuits (30, 40) of the humidity control units (11, 12), the second adsorption heat exchangers (32, 42) serve as condensers and the first adsorption heat exchangers (31, 41) serve as evaporators. Specifically, refrigerant discharged from the compressor (21) and distributed to each humidity control circuit (30, 40) condenses in the second adsorption heat exchanger (32, 42), is reduced in pressure during passage through the motor-operated expansion valve (33, 43), evaporates in the first adsorption heat exchanger (31, 41), is then sucked into the compressor (21) and compressed therein. Further, the second air is humidified in each second adsorption heat exchanger (32, 42) serving as a condenser, while the first air is dehumidified in each first adsorption heat exchanger (31, 41) serving as an evaporator.

As described above, in each humidity control unit (11, 12), the first air is dehumidified in one of the first adsorption heat exchanger (31, 41) and the second adsorption heat exchanger (32, 42) which serves as an evaporator while the second air is humidified in the other serving as a condenser. Then, during dehumidification operation, the humidity control unit (11, 12) supplies the dehumidified first air to the room and exhausts the humidified second air to the outside atmosphere (see FIG. 18). On the other hand, during humidification operation, the humidity control unit (11, 12) supplies the humidified second air to the room and exhausts the dehumidified first air to the outside atmosphere (see FIG. 19).

Thus, in each humidity control unit (11, 12), switching between the dehumidifying and humidification operations can be accomplished by changing the destinations of the first and second airs having passed through the adsorption heat exchangers (31, 32, 41, 42). Further, if setting is made so that the destinations of the first and second airs differ between the humidity control units (11, 12), as shown in FIG. 20, it is possible that one humidity control unit (11) performs a dehumidification operation and the other humidity control unit (12) performs a humidification operation.

### Effects of Embodiment 2

In this embodiment, the humidity control four-way selector valves (34, 44) are provided in their respective humidity control units (11, 12). Therefore, the flow direction of refrigerant in the humidity control circuit (30, 40) in each humidity control unit (11, 12) can be individually selected by the associated humidity control four-way selector valve (34, 44). Consequently, according to this embodiment, the timing to switch between the first and second modes can be set for each humidity control unit (11, 12).

### Embodiment 3 of the Invention

A description is given of Embodiment 3 of the invention. This embodiment differs from the humidity control system (10) of Embodiment 2 in the structures of the first and second humidity control units (11, 12). Here, the description is given only of the structure of the first humidity control unit (11); the first humidity control unit (11) and the second humidity control unit (12) have the same structure. Note that the following terms used in the description, “upper”, “lower”, “left”, “right”, “front”, “rear” “in front” and “behind”, refer to directionalities when the humidity control units (11, 12) are viewed from in front.

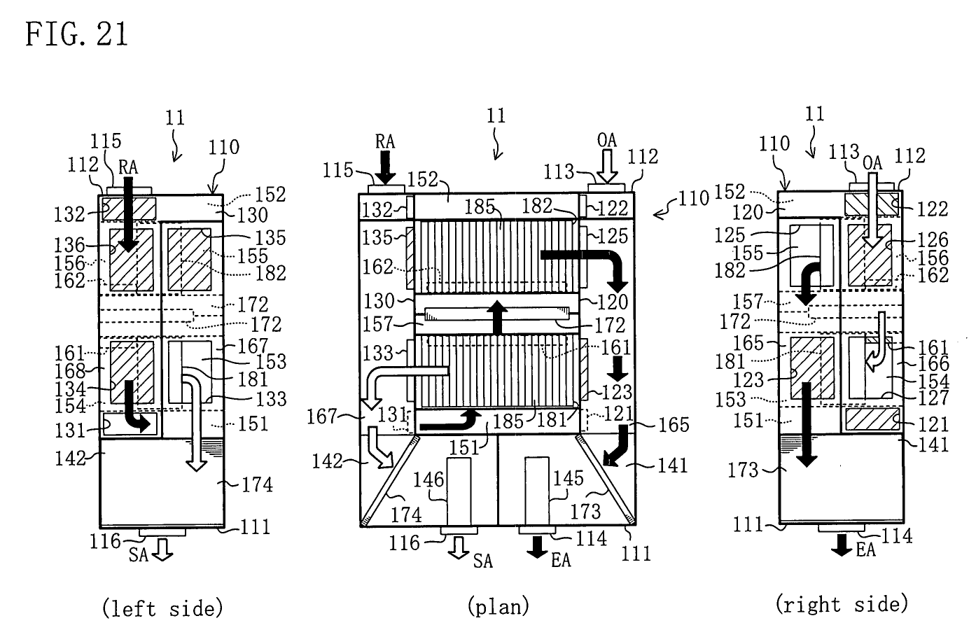

As shown in FIG. 21, the first humidity control unit (11) includes a casing (110) of small-height, flattish, rectangular parallelepiped shape. The casing (110) contains two adsorption elements (181, 182) and a humidity control circuit (30, 40). The humidity control circuit (30, 40) is provided with a regeneration heat exchanger (172), a first heat exchanger (173), a second heat exchanger (174) and an expansion valve. Note that the expansion valve is not given in FIG. 21. In this humidity control circuit (30, 40), the regeneration heat exchanger (172) functions as a condenser. Further, the humidity control circuit (30, 40) can be switched between a mode in which the first heat exchanger (173) serves as an evaporator and the second heat exchanger (174) is in non-operating condition and a mode in which the second heat exchanger (174) serves as an evaporator and the first heat exchanger (173) is in non-operating condition. The humidity control circuit (30, 40) is connected at its end toward the regeneration heat exchanger (172) to the discharge side of the compressor (21) in the outdoor circuit (20) and connected at its end toward the first and second heat exchangers (173, 174) to the suction side of the compressor (21) in the outdoor circuit (20).

Each adsorption element (181, 182) is formed in a flattish, rectangular parallelepiped shape. In the adsorption element (181, 182), humidity control channels (185) and cooling channels (186) are alternately defined in layers in the longitudinal direction of the adsorption element (181, 182), one layer including a plurality of channels. The humidity control channels (185) are open at the top and bottom sides of the adsorption element (181, 182). An adsorbent is applied to the surfaces of the adsorption element (181, 182) facing the humidity control channels (185). On the other hand, the cooling channels (186) are open at the front and rear sides of the adsorption element (181, 182). In the adsorption element (181, 182), the air flowing through the cooling channels (186) exchanges heat with the air flowing through the humidity control channels (185).

As shown in FIG. 21, in the casing (110), a first panel (111) located at the front is formed with an exhaust opening (114) and an air supply opening (116) and a second panel (112) located at the rear is formed with an outdoor air suction opening (113) and an indoor air suction opening (115). The exhaust opening (114) is open in the right side of the first panel (111) slightly toward the center, while the air supply opening (116) is open in the left side thereof slightly toward the center. The outdoor air suction opening (113) is open in a lower part of the second panel (112) toward the right end, while the indoor air suction opening (115) is open in the lower part thereof toward the left end.

The interior of the casing (110) is divided into a front space and a rear space.

The front space in the casing (110) is divided into right and left spaces. The right space constitutes a first space (141) and the left space constitutes a second space (142). The first space (141) communicates through the exhaust opening (114) with the outside atmosphere and is internally provided with an exhaust fan (145) and the first heat exchanger (173). The second space (142) communicates through the air supply opening (116) with the room and is internally provided with an air supply fan (146) and the second heat exchanger (174).

The rear space in the casing (110) includes a right partition plate (120) and a left partition plate (130) standing vertically therein. The rear space is divided from left to right into three spaces by the right partition plate (120) and the left partition plate (130).

The space between the right side panel of the casing (110) and the right partition plate (120) is divided from top to bottom. The upper part of this space constitutes an upper right passage (165) and the lower part thereof constitutes a lower right passage (166). The upper right passage (165) communicates through the first space (141) and the exhaust opening (114) with the outside atmosphere. The lower right passage (166) communicates through the outdoor air suction opening (113) with the outside atmosphere.

The space between the left side panel of the casing (110) and the left partition plate (130) is divided from top to bottom. The upper part of this space constitutes an upper left passage (167) and the lower part thereof constitutes a lower left passage (168). The upper left passage (167) communicates through the second space (142) and the air supply opening (116) with the room. The lower left passage (168) communicates through the indoor air suction opening (115) with the room.

The two adsorption elements (181, 182) are placed in the space between the right partition plate (120) and the left partition plate (130) in the casing (110). The two adsorption elements (181, 182) are arranged apart from each other in the front-to-rear direction. Specifically, the first adsorption element (181) is placed toward the front of the casing (110) and the second adsorption element (182) is placed toward the rear thereof. Each adsorption element (181, 182) has the humidity control channels (185) open at its top and bottom sides and the cooling channels (186) open at its front and rear sides.

The space between the right partition plate (120) and the left partition plate (130) in the casing (110) is divided into a first passage (151), a second passage (152), a first upper passage (153), a first lower passage (154), a second upper passage (155), a second lower passage (156) and a middle passage (157).

The first passage (151) is formed in front of the first adsorption element (181) and communicates with the cooling channels (186) of the first adsorption element (181). The second passage (152) is formed behind the second adsorption element (182) and communicates with the cooling channels (186) of the second adsorption element (182).

The first upper passage (153) is formed on top of the first adsorption element (181) and communicates with the humidity control channels (185) of the first adsorption element (181). The first lower passage (154) is formed under the first adsorption element (181) and communicates with the humidity control channels (185) of the first adsorption element (181). The second upper passage (155) is formed on top of the second adsorption element (182) and communicates with the humidity control channels (185) of the second adsorption element (182). The second lower passage (156) is formed under the second adsorption element (182) and communicates with the humidity control channels (185) of the second adsorption element (182).

The middle passage (157) is formed between the first adsorption element (181) and the second adsorption element (182) and communicates with the cooling channels (186) of both the adsorption elements (181, 182). The middle passage (157) contains the regeneration heat exchanger (172) disposed uprightly therein.

The partition between the middle passage (157) and the first lower passage (154) has a first middle damper (161) provided at a lower part thereof. The first middle damper (161) provides and interrupts communication between the middle passage (157) and the first lower passage (154). The partition between the middle passage (157) and the second lower passage (156) has a second middle damper (162) provided at a lower part thereof. The second middle damper (162) provides and interrupts communication between the middle passage (157) and the second lower passage (156).

The right partition plate (120) is provided with a first right damper (121), a second right damper (122), a first upper right damper (123), a first lower right damper (124), a second upper right damper (125) and a second lower right damper (126).

The first right damper (121) is provided in the lower part of the right partition plate (120) most toward the front and provides and interrupts communication between the first passage (151) and the lower right passage (166). The second right damper (122) is provided in the lower part of the right partition plate (120) most toward the rear and provides and interrupts communication between the second passage (152) and the lower right passage (166).

The first upper right damper (123) is provided at the upper part of the right partition plate (120) adjacent the first adsorption element (181) and provides and interrupts communication between the first upper passage (153) and the upper right passage (165). The first lower right damper (124) is provided at the lower part of the right partition plate (120) adjacent the first adsorption element (181) and provides and interrupts between the first lower passage (154) and the lower right passage (166). The second upper right damper (125) is provided at the upper part of the right partition plate (120) adjacent the second adsorption element (182) and provides and interrupts communication between the second upper passage (155) and the upper right passage (165). The second lower right damper (126) is provided at the lower part of the right partition plate (120) adjacent the second adsorption element (182) and provides and interrupts communication between the second lower passage (156) and the lower right passage (166).

The left partition plate (130) is provided with a first left damper (131), a second left damper (132), a first upper left damper (133), a first lower left damper (134), a second upper left damper (135) and a second lower left damper (136).

The first left damper (131) is provided at the lower part of the left partition plate (130) toward the front and provides and interrupts communication between the first passage (151) and the lower left passage (168). The second left damper (132) is provided at the lower part of the left partition plate (130) toward the rear and provides and interrupts communication between the second passage (152) and the lower left passage (168).

The first upper left damper (133) is provided at the upper part of the left partition plate (130) adjacent the first adsorption element (181) and provides and interrupts communication between the first upper passage (153) and the upper left passage (167). The first lower left damper (134) is provided at the lower part of the left partition plate (130) adjacent the first adsorption element (181) and provides and interrupts communication between the first lower passage (154) and the lower left passage (168). The second upper left damper (135) is provided at the upper part of the left partition plate (130) adjacent the second adsorption element (182) and provides and interrupts communication between the second upper passage (155) and the upper left passage (167). The second lower left damper (136) is provided at the lower part of the left partition plate (130) adjacent the second adsorption element (182) and provides and interrupts communication between the second lower passage (156) and the lower left passage (168).

—Operational Behavior—

Like Embodiments 1 and 2, also in this embodiment, the first humidity control unit (11) and the second humidity control unit (12) have a common structure and common operational behaviors. Here, a description will be given of the behavior of the first humidity control unit (11), but not the behavior of the second humidity control unit (12).

<Dehumidification Operation>

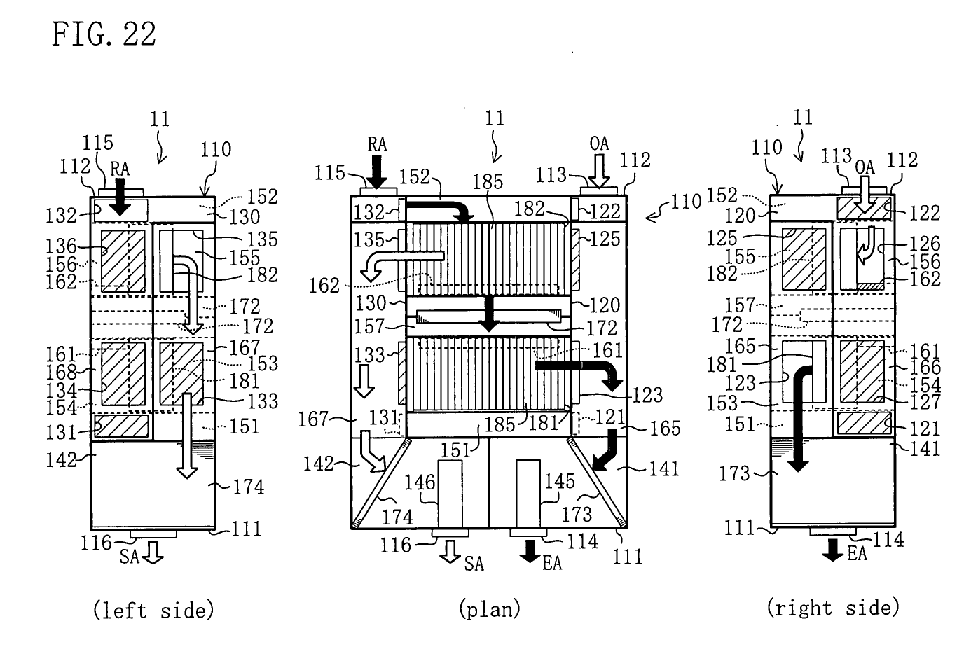

As shown in FIGS. 21 and 22, when the air supply fan (146) is driven in the dehumidification operation, outdoor air (OA) is taken as a first air through the outdoor air suction opening (113) into the casing (110). Further, when the exhaust fan (145) is driven, room air (RA) is taken as a second air through the indoor air suction opening (115) into the casing (110). In the humidity control circuit (30, 40) during dehumidification operation, the regeneration heat exchanger (172) serves as a condenser, the second heat exchanger (174) serves as an evaporator, and the first heat exchanger (173) is deactivated. Under these conditions, the first humidity control unit (11) alternately repeats a first mode and a second mode.

The first mode of the dehumidification operation is described with reference to FIG. 21. In the first mode, the first humidity control unit (11) performs an adsorption action for the first adsorption element (181) and a regeneration action for the second adsorption element (182).

During the first mode, in the right partition plate (120), the first lower right damper (124) and the second upper right damper (125) are open and the other dampers (121, 122, 123, 126) are closed. Further, in the left partition plate (130), the first left damper (131) and the first upper left damper (133) are open and the other dampers (132, 134, 135, 136) are closed. The first middle damper (161) is closed and the second middle damper (162) is open.

The first air taken in the casing (110) flows through the lower right passage (166), through the first lower right damper (124) and into the first lower passage (154). The first air in the first lower passage (154) flows into the humidity control channels (185) in the first adsorption element (181). In the humidity control channels (185), water vapor in the first air is adsorbed on the adsorbent. The first air dehumidified in the first adsorption element (181) flows into the first upper passage (153), passes through the first upper left damper (133) and the upper left passage (167) in this order and then flows into the second space (142). In the second space (142), the first air exchanges heat with the refrigerant in the second heat exchanger (174) during passage therethrough and is thereby cooled. Thus, the dehumidified and cooled first air is supplied through the air supply opening (116) to the room.

On the other hand, the second air taken in the casing (110) flows through the lower left passage (168), through the first left damper (131), into the first passage (151) and then into the cooling channels (186) in the first adsorption element (181). During passage through the cooling channels (186), the second air takes heat of adsorption produced in the humidity control channels (185). The second air having taken the heat of adsorption flows into the middle passage (157), passes through the regeneration heat exchanger (172) and, during the passage through it, exchanges heat with the refrigerant in it and is thereby further heated.

The heated second air flows from the middle passage (157) into the second lower passage (156) and then flows into the humidity control channels (185) in the second adsorption element (182). In the humidity control channels (185), the adsorbent is heated by the second air so that water vapor is desorbed from the adsorbent. The water vapor desorbed from the adsorbent is applied to the second air. The second air humidified in the humidity control channels (185) flows into the second upper passage (155), passes through the second upper right damper (125) and the upper right passage (165) in this order and then flows into the first space (141). Then, the second air passes through the first heat exchanger (173) in non-operating condition and is exhausted through the exhaust opening (114) to the outside atmosphere.

The second mode of the dehumidification operation is described with reference to FIG. 22. In the second mode, the first humidity control unit (11) performs an adsorption action for the second adsorption element (182) and a regeneration action for the first adsorption element (181).

During the second mode, in the right partition plate (120), the first upper right damper (123) and the second lower right damper (126) are open and the other dampers (121, 122, 124, 125) are closed. Further, in the left partition plate (130), the second left damper (132) and the second upper left damper (135) are open and the other dampers (131, 133, 135, 136) are closed. The first middle damper (161) is open and the second middle damper (162) is closed.

The first air taken in the casing (110) flows through the lower right passage (166), through the second lower right damper (126) and into the second lower passage (156). The first air in the second lower passage (156) flows into the humidity control channels (185) in the second adsorption element (182). In the humidity control channels (185), water vapor in the first air is adsorbed on the adsorbent. The first air dehumidified in the second adsorption element (182) flows into the second upper passage (155), passes through the second upper left damper (135) and the upper left passage (167) in this order and then flows into the second space (142). In the second space (142), the first air exchanges heat with the refrigerant in the second heat exchanger (174) during passage therethrough and is thereby cooled. Thus, the dehumidified and cooled first air is supplied through the air supply opening (116) to the room.

On the other hand, the second air taken in the casing (110) flows through the lower left passage (168), through the second left damper (132), into the second passage (152) and then into the cooling channels (186) in the second adsorption element (182). During passage through the cooling channels (186), the second air takes heat of adsorption produced in the humidity control channels (185). The second air having taken the heat of adsorption flows into the middle passage (157), passes through the regeneration heat exchanger (172) and, during the passage through it, exchanges heat with the refrigerant in it and is thereby further heated.

The heated second air flows from the middle passage (157) into the first lower passage (154) and then flows into the humidity control channels (185) in the first adsorption element (181). In the humidity control channels (185), the adsorbent is heated by the second air so that water vapor is desorbed from the adsorbent. The water vapor desorbed from the adsorbent is applied to the second air. The second air humidified in the humidity control channels (185) flows into the first upper passage (153), passes through the first upper right damper (123) and the upper right passage (165) in this order and then flows into the first space (141). Then, the second air passes through the first heat exchanger (173) in non-operating condition and is exhausted through the exhaust opening (114) to the outside atmosphere.

<Humidification Operation>

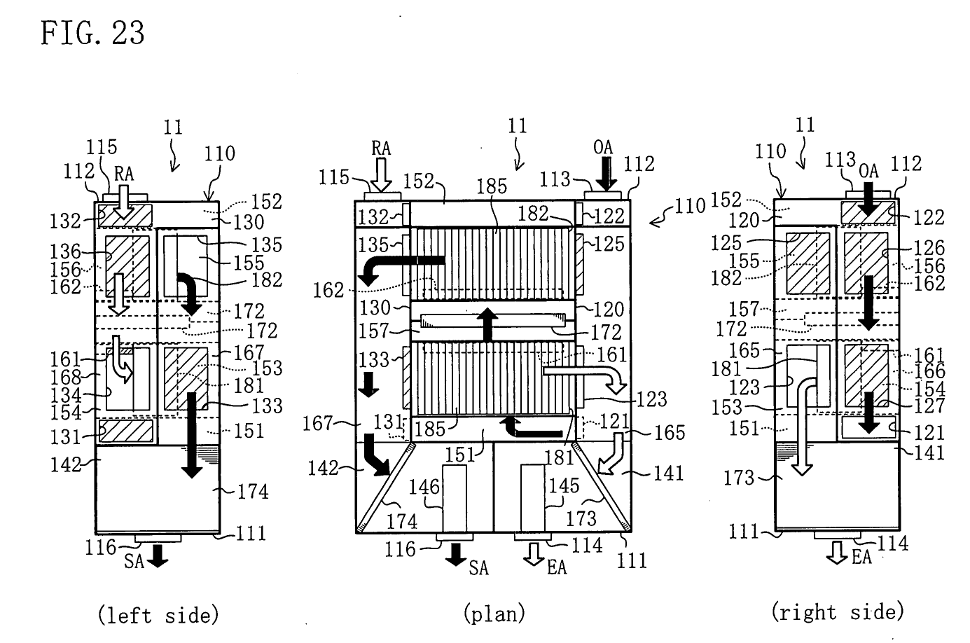

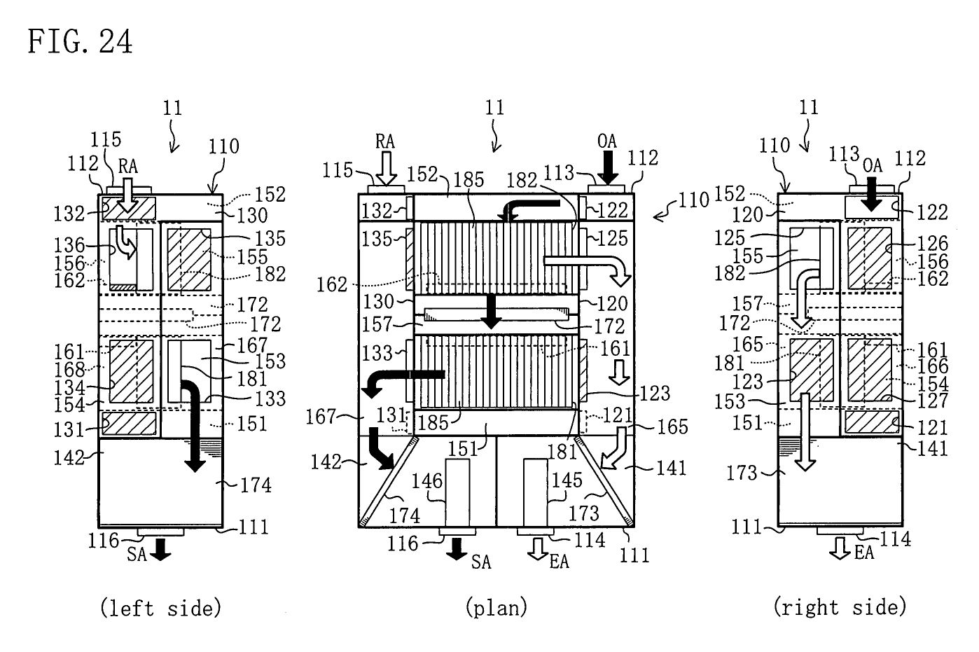

As shown in FIGS. 23 and 24, when the air supply fan (146) is driven in the humidification operation, outdoor air (OA) is taken as a second air through the outdoor air suction opening (113) into the casing (110). Further, when the exhaust fan (145) is driven, room air (RA) is taken as a first air through the indoor air suction opening (115) into the casing (110). In the humidity control circuit (30, 40) during humidification operation, the regeneration heat exchanger (172) serves as a condenser, the first heat exchanger (173) serves as an evaporator, and the second heat exchanger (174) is deactivated. Under these conditions, the first humidity control unit (11) alternately repeats a first mode and a second mode.

The first mode of the humidification operation is described with reference to FIG. 23. In the first mode, the first humidity control unit (11) performs an adsorption action for the first adsorption element (181) and a regeneration action for the second adsorption element (182).

During the first mode, in the right partition plate (120), the first right damper (121) and the first upper right damper (123) are open and the other dampers (122, 124, 125, 126) are closed. Further, in the left partition plate (130), the first lower left damper (134) and the second upper left damper (135) are open and the other dampers (131, 132, 133, 136) are closed. The first middle damper (161) is closed and the second middle damper (162) is open.

The first air taken in the casing (110) flows through the lower left passage (168), through the first lower left damper (134) and into the first lower passage (154). The first air in the first lower passage (154) flows into the humidity control channels (185) in the first adsorption element (181). In the humidity control channels (185), water vapor in the first air is adsorbed on the adsorbent. The first air dried in the first adsorption element (181) flows into the first upper passage (153), passes through the first upper right damper (123) and the upper right passage (165) in this order and then flows into the first space (141). In the first space (141), the first air exchanges heat with the refrigerant in the first heat exchanger (173) during passage therethrough and is thereby cooled. Thus, the first air having lost moisture and heat is exhausted through the exhaust opening (114) to the outside atmosphere.

On the other hand, the second air taken in the casing (110) flows through the lower right passage (166), through the first right damper (121), into the first passage (151) and then into the cooling channels (186) in the first adsorption element (181). During passage through the cooling channels (186), the second air takes heat of adsorption produced in the humidity control channels (185). The second air having taken the heat of adsorption flows into the middle passage (157), passes through the regeneration heat exchanger (172) and, during the passage through it, exchanges heat with the refrigerant in it and is thereby heated.

The heated second air flows from the middle passage (157) into the second lower passage (156) and then flows into the humidity control channels (185) in the second adsorption element (182). In the humidity control channels (185), the adsorbent is heated by the second air so that water vapor is desorbed from the adsorbent. The water vapor desorbed from the adsorbent is applied to the second air. The second air humidified in the second adsorption element (182) flows into the second upper passage (155), passes through the second upper left damper (135) and the upper left passage (167) in this order and then flows into the second space (142). Then, the second air passes through the second heat exchanger (174) in non-operating condition and is supplied through the air supply opening (116) to the room.

The second mode of the humidification operation is described with reference to FIG. 24. In the second mode, the first humidity control unit (11) performs an adsorption action for the second adsorption element (182) and a regeneration action for the first adsorption element (181).

During the second mode, in the right partition plate (120), the second right damper (122) and the second upper right damper (125) are open and the other dampers (121, 123, 124, 126) are closed. Further, in the left partition plate (130), the first upper left damper (133) and the second lower left damper (136) are open and the other dampers (131, 132, 134, 135) are closed. The first middle damper (161) is open and the second middle damper (162) is closed.

The first air taken in the casing (110) flows through the lower left passage (168), through the second lower left damper (136) and into the second lower passage (156). The first air in the second lower passage (156) flows into the humidity control channels (185) in the second adsorption element (182). In the humidity control channels (185), water vapor in the first air is adsorbed on the adsorbent. The first air dried by the second adsorption element (182) flows into the second upper passage (155), passes through the second upper right damper (125) and the upper right passage (165) in this order and then flows into the first space (141). In the first space (141), the first air exchanges heat with the refrigerant in the first heat exchanger (173) during passage therethrough and is thereby cooled. Thus, the first air having lost moisture and heat is exhausted through the exhaust opening (114) to the outside atmosphere.

On the other hand, the second air taken in the casing (110) flows through the lower right passage (166), through the second right damper (122), into the second passage (152) and then into the cooling channels (186) in the second adsorption element (182). During passage through the cooling channels (186), the second air takes heat of adsorption produced in the humidity control channels (185). The second air having taken the heat of adsorption flows into the middle passage (157), passes through the regeneration heat exchanger (172) and, during the passage through it, exchanges heat with the refrigerant in it and is thereby heated.

The heated second air flows from the middle passage (157) into the first lower passage (154) and then flows into the humidity control channels (185) in the first adsorption element (181). In the humidity control channels (185), the adsorbent is heated by the second air so that water vapor is desorbed from the adsorbent. The water vapor desorbed from the adsorbent is applied to the second air. The second air humidified in the humidity control channels (185) flows into the first upper passage (153). Then, the second air humidified in the first adsorption element (181) flows into the first upper passage (153), passes through the first upper left damper (133) and the upper left passage (167) in this order and then flows into the second space (142). Then, the second air passes through the second heat exchanger (174) in non-operating condition and is supplied through the air supply opening (116) to the room.

### INDUSTRIAL APPLICABILITY

As can be seen from the above, the present invention is useful for humidity control systems for supplying dehumidified or humidified air to rooms.

1. A humidity control system comprising:
a plurality of humidity control units (11, 12) each for selectively performing a dehumidification operation of supplying dehumidified air to a room and a humidification operation of supplying humidified air to the room;
a single compressor unit (13) having a compressor (21) disposed therein;
each said humidity control unit (11, 12) being connected to the compressor unit (13) to form a refrigerant circuit (15) and configured to control the humidity of air by carrying out at least one of heating and cooling of an adsorbent using refrigerant in the refrigerant circuit (15) and bringing the air into contact with the adsorbent; and
any one of the humidity control units (11, 12) being capable of selecting either the dehumidification operation or the humidification operation regardless of the other humidity control units (11, 12) being during dehumidification operation or humidification operation.

2. The humidity control system of claim 1, wherein each said humidity control unit (11, 12) includes an adsorption heat exchanger (31, 32, 41, 42) carrying the adsorbent and connected to the refrigerant circuit (15) and is configured to feed air taken therein to the adsorption heat exchanger (31, 32, 41, 42) and bring the air into contact with the adsorbent.

3. The humidity control system of claim 2, wherein
each said humidity control unit (11, 12) is configured to take a first air and a second air and alternately perform a mode of dehumidifying the first air in a first adsorption heat exchanger (31, 41) serving as an evaporator and humidifying the second air in a second adsorption heat exchanger (32, 42) serving as a condenser and another mode of dehumidifying the first air in the second adsorption heat exchanger (32, 42) serving as an evaporator and humidifying the second air in the first adsorption heat exchanger (31, 41) serving as a condenser, and
each said humidity control unit (11, 12) is configured, during dehumidification operation, to supply the dehumidified first air to the room while exhausting the humidified second air to the outside atmosphere and is configured, during humidification operation, to supply the humidified second air to the room while exhausting the dehumidified first air to the outside atmosphere.

4. The humidity control system of claim 3, wherein
each said humidity control unit (11, 12) includes a humidity control circuit (30, 40) formed therein by connecting the first adsorption heat exchanger (31, 41), an expansion mechanism (33, 43) and the second adsorption heat exchanger (32, 42) in series in this order, said humidity control circuit (30, 40) constituting part of the refrigerant circuit (15), and
the compressor unit (13) includes an inversion mechanism (22), connected to the refrigerant circuit (15), for inverting the direction of flow of the refrigerant through all the humidity control circuits (30, 40).

5. The humidity control system of claim 3, wherein
each said humidity control unit (11, 12) includes a humidity control circuit (30, 40) formed therein by connecting the first adsorption heat exchanger (31, 41), an expansion mechanism (33, 43) and the second adsorption heat exchanger (32, 42) in series in this order, said humidity control circuit (30, 40) constituting part of the refrigerant circuit (15), and
the humidity control circuit (30, 40) includes an inversion mechanism (34, 44) connected therein for inverting the direction of flow of the refrigerant through the humidity control circuit (30, 40).
